(19) United States
(12) Patent Application Publication
(10) Pub. No.: US 2020/0055595 A1
(43) Pub. Date: Feb. 20, 2020

(54) CRUISE EFFICIENT VERTICAL AND SHORT TAKE-OFF AND LANDING AIRCRAFT

(71) Applicant: William Bailie, White Rock (CA)

(72) Inventor: William Bailie, White Rock (CA)

(21) Appl. No.: 16/487,396

(22) PCT Filed: Feb. 20, 2018
(86) PCT No.: PCT/CA2018/050193

§ 371 Date: Aug. 20, 2019

(30) Foreign Application Priority Data
Feb. 20, 2017 (CA) 2958361

(51) Int. Cl. B64C 29/00

(52) U.S. Cl. CPC B64C 29/0016

(57) ABSTRACT

An apparatus for providing lift to an aircraft comprising at least one rotating lifting device (RLD) formed of a pair of RLD segments extending from a common vertical support pivotally supported by the aircraft, a drive operable to rotate the at least one RLD relative to the aircraft and a lock operable to fix the at least one RLD relative to the aircraft at a plurality of orientations. The RLD segments may include a plurality of aerodynamic adjustment features to adjust the aerodynamic profile of the RLD segments as the RLD is converted from a rotating lifting body to a stationary lifting body.

### TECHNICAL FIELD

The present invention relates to a cruise-efficient vertical and short take-off and landing (“CEVSTOL”) aircraft and related systems.

### BACKGROUND

A vertical take-off and landing (“VTOL”) aircraft is one that can take off, hover, and land vertically. A helicopter is a common example of a VTOL aircraft.

Some VTOL aircraft, such as the Harrier® family of aircraft using directed jet thrust, can operate in other modes as well, such as in conventional take-off and landing (“CTOL”), short take-off and landing (“STOL”), and/or vertical and short take-off and vertical landing (“VSTOL”). However other VTOL aircraft, such as most helicopters, can only operate as VTOL aircraft, due to the absence of landing gear which would otherwise be capable of handling a horizontal ground travel.

VTOL aircraft have challenges achieving rapid forward flight.

The rotorcraft Bell® Boeing® V-22 Osprey is a tilt-rotor VTOL aircraft used in military service. The V-22 Osprey is so large that it is unable to transition into forward flight until a cruising altitude is reached after vertical take-off and has a very small margin of error for transitioning from vertical take-off to forward flight and vice versa. The resulting probability of a catastrophic failure is high. The V-22 Osprey, for example, has had at least seven hull-loss accidents with at least thirty-six fatalities.

Helicopters are usable in congested and/or isolated areas where conventional fixed-wing aircraft would be unable to take-off and/or land. However, the long rotating blades, which allow a helicopter to hover for extended periods of time, tend to restrict the maximum speed of helicopters to about 250 miles per hour (400 km/h) as retreating blade stall causes lateral instability.

Prior art aircraft are inefficient in their ability to transition from vertical take-off and/or hovering to fast forward flight.

There is a need for an aircraft, and related enabling systems, that has the capability to make vertical take-offs and landings and/or short take-offs and vertical landings and can also easily transition to fast and efficient forward flight and back again.

### SUMMARY OF THE INVENTION

According to a first embodiment of the present invention there is disclosed an apparatus for providing lift to an aircraft comprising at least one rotating lifting device (RLD) formed of a pair of RLD segments extending from a common vertical support pivotally supported by the aircraft, a drive operable to rotate the at least one RLD relative to the aircraft and a lock operable to fix the at least one RLD relative to the aircraft at a plurality of orientations.

The apparatus may further comprise at least two RLDs coaxially and independently rotatably supported by the aircraft. Each of the at least two RLDs may be rotatably supported on a drive hub. Each of the at least two RLD may include a locking extension selectably engageable upon the drive hub. The locking extensions may be receivable in apertures in the drive hub.

The drive hub may include a plurality of apertures disposed radially therearound so as to permit a plurality of locked orientations for each of the at least two RLDs. The apparatus may further comprise an interlock adapted to rotatably couple the at least two RLDs together. The interlock may comprise a receiver extending from at least one of the at least two rotors having a plurality of apertures and at least one pin supported on another of the at least two rotors adapted to be selectably engageable within the one of the plurality of apertures.

The apparatus may further comprise an air supply passage extending through each of the RLD segments, the air supply passage fluidically connected to a pressurized air supply within the aircraft and a plurality of air outlets disposed along each of the RLD segments in fluidic communication with the air passage. The plurality of air outlets may be disposed along at least one of a leading and trailing edges of the RLD segments.

The apparatus may further comprise a plurality of air outlet nozzles along each of the leading and trailing edges. The trailing edge outlets may discharge air substantially along a chord of the RLD segments away therefrom. The leading edge outlets may discharge air along a top and bottom surface of the RLD segments in a direction extending from the leading edge to the trailing edge along the top and bottom surface of the at least two rotors. The leading and trailing outlets may be substantially similar.

The plurality of outlets may be formed of a cylinder extendable from the leading and trailing edge substantially along the chord of the RLD segments, each of the cylinder defining a selectably open central passage along the chord and upper and lower bores passing through the cylinder. The cylinder may be extendable from the RLD segments so as to uncover the upper and lower bores. The cylinder further may include a shield corresponding to the profile of the at least two rotors extending from a distal end thereof and overlying the upper and lower bores so as to direct air discharged therefrom along top and bottom surfaces of the RLD segments.

The plurality of air outlets may be adapted to provide a rotational force to each of the RLD segments. The plurality of air outlets may be located at distal ends of the RLD segments. The plurality of air outlets may be oriented perpendicular to the RLD segments. The plurality of air outlets may be rotatable about a length of each of the RLD segments. The plurality of air outlets may each includes two outlets disposed in opposite directions.

The plurality of air outlets may comprise a plurality of linked pairs of air outlets. The linked pairs of outlets may comprise an edge outlet located proximal to one of a leading or trailing edge of the at least two rotors to a position and a top outlet positioned through a top surface of the at least two rotors at a position past a midpoint of the RLD segments. The linked pair of outlets may be connected by a passage extending therebetween. The passage may be pressurized to direct air towards a trailing edge of the RLD segment.

The plurality of air outlets may comprise a plurality of leading edge outlets proximal to a leading edge and a plurality of trailing edge outlets proximal to a trailing edge of the RLD segments. The leading edge outlets and the trailing edge outlets may be connected by a bridging duct. The bridging duct may include a modulating valve adapted to control the flow of air therethrough.

The apparatus may further comprise a track extending along a portion of a length of each of the RLD segments and a weighted body selectably positionable along the track. The track may comprise a cylinder. The weighted body may comprise a piston within the cylinder. The cylinder may include an air supply adapted to slideably move the piston within the cylinder.

The RLD segments may be rotatably supported along an axial length thereof. The RLD segments may be rotatably supported about an air supply plenum extending therethrough. The apparatus may further comprise an actuator adapted to rotate the RLD segments relative to the air supply passage. The actuator may comprise a gear engaged upon a splined arcuate surface of the RLD segments.

The apparatus may further comprise a moveable portion disposed along one of the trailing edge of each of the RLD segments. The moveable portion may comprise a pair of top and bottom flaps extending along the trailing edge. The top and bottom flaps may be hinged along the corresponding top or bottom surface of the at least two rotors. The top and bottom flaps may extend to a distal edge proximate to the trailing edge of the at least two RLD segments.

The apparatus may further comprise an actuating rod extending from each of the top and bottom flaps. Each actuating rod may extend to an actuator adapted to rotate the top and bottom flap in the same direction as each other. The actuator may comprise a rotary actuator. The actuating rods may be connected to the rotary actuator ad different angular positions thereon. The actuating rods may cross between the top and bottom flaps and the actuator.

According to a further embodiment of the present invention there is disclosed a system for transforming an aircraft comprising a RLD assembly and a RLD control system operably coupled with the RLD assembly. The RLD assembly comprises a concentric gimbaled RLD hub plenum and support assembly, a RLD rotatably and lockably coupled with the concentric RLD hub plenum and support assembly and the RLD comprising a leading edge and a trailing edge, as well as an upper and lower surface, the leading edge substantially symmetric in relation to the trailing edge, and the leading edge, and the upper surface, each comprising a aerodynamic profile adjustment feature. The RLD control system is configured to selectively control angular velocity of the RLD, selectively lock and selectively unlock the RLD, selectively reorient the RLD in relation to the hub plenum and support assembly, selectively adjust the aerodynamic profile of the leading edge, the trailing edge, and the upper surface, and selectively lock and selectively unlock the RLD in relation to any other RLD, wherein the RLD assembly is reorientable through the gimbal and whereby the RLD is respectively configurable as an wing for transforming the aircraft.

The RLD control system may be configured to selectively reorient at least one of each RLD in relation to the at least one corresponding gimbaled RLD hub plenum and support assembly in at least one parameter of effective pitch, angle of incidence, effective camber, sweep, aerodynamic chord length, span and aspect ratio for facilitating transitioning from at least one of vertical take-off and short take-off to forward flight as well as from forward flight to at least one of vertical landing and short landing and conventional take-off and landing, and wherein the RLD control system is configured to selectively reorient at least one of each RLD to have at least one of zero sweep, forward sweep, back sweep, symmetric sweep, asymmetric sweep, and oblique sweep. Each RLD may be spaced-apart from any other RLD.

The system system may further comprise at least one attitude control device configured to couple with the aircraft. The at least one attitude control device may comprise at least one fan.

The RLD control system may be configured to selectively control angular velocity of the at least one RLD and is further configured to perform at least one of selectively stop and selective start rotation of at least one of each RLD for further facilitating transition between hovering and forward flight. Each RLD may comprise at least one of a variable span and an variable aerodynamic airfoil shape, the variable aerodynamic airfoil shape comprising at least one of a plurality of shapes. The concentric RLD hub plenum and support assembly may comprises at least one plenum for accommodating at least one of a mechanical actuation system, an electromechanical actuation system, and a gas-driven actuation system.

According to a further embodiment of the present invention there is disclosed a method of fabricating a system for transforming an aircraft, the method comprising providing a gimbaled RLD assembly, the RLD assembly comprising providing at least one concentric RLD huh plenum and support assembly, providing at least one RLD rotatably and lockably coupled with each at least one corresponding concentric RLD hub plenum and support assembly, and providing at least one of at least one RLD pivotally and lockably coupled with each at least one corresponding RLD, the at least one of each RLD comprising a leading edge and a trailing edge, the leading edge substantially symmetric in relation to the trailing edge, and the leading edge and the trailing edge and upper surface, each comprising an aerodynamic profile adjustment feature and providing a RLD control system operably coupled with the RLD assembly, the RLD control system providing comprising configuring the RLD control system to: selectively control angular velocity of the at least one RLD, at least one of selectively lock and selectively unlock the at least one RLD, selectively reorient at least one of each RLD in relation to the at least one corresponding RLD system hub plenum support assembly, selectively adjust the aerodynamic profile of at least one of the leading edge and the trailing edge and upper surface; and at least one of selectively lock and selectively unlock at least one of each RLD in relation to the at least one corresponding RLD, whereby the at least one of each RLD is respectively configurable as a pair of wings for transforming the aircraft.

The step of transforming may comprise a transition of vertical take-off to hovering, short take-off to hovering, hovering to forward flight, forward flight to hovering, hovering to vertical landing, and hovering to short landing and further facilitating transition between hovering and forward flight. The step of providing the RLD control system may comprise configuring the RLD control system to selectively reorient at least one of each RLD in relation to the at least one corresponding plenum and support assembly in at least one parameter of pitch, angle of incidence, effective camber, sweep, aerodynamic chord length, span and aspect ratio for facilitating transitioning from at least one of vertical take-off and short take-off to forward flight as well as from forward flight to at least one of vertical landing and short landing, and wherein providing the RLD control system comprises configuring the RLD control system to selectively reorient at least one of each RLD to have at least one of zero sweep, forward sweep, back sweep, symmetric sweep, asymmetric sweep, and oblique sweep.

The step of providing the RLD assembly may comprise spacing-apart each RLD from any other RLD. The method may further comprise providing at least one attitude control device configured to couple with the aircraft. The step of providing the at least one attitude control device may comprise providing at least one fan. The step of providing the RLD control system may comprise configuring the RLD control system to selectively control angular velocity of the at least one RLD, is further configured to selectively start and stop rotation of each at least one RLD. The step of providing the RLD control system may comprise configuring the RLD control system to selectively control angular velocity of the at least one RLD, is further configured to perform at least one of selectively stop and selective start rotation of at least one of each RLD for further facilitating transition between hovering and forward flight.

Each RLD may comprise at least one of an adjustable span and an adjustable aerodynamic airfoil shape, the adjustable airfoil shape comprising at least one of a plurality of shapes. The step of providing the RLD assembly may comprise providing the concentric RLD huh plenum and support assembly with at least one plenum for accommodating at least one of a mechanical actuation system, an electromechanical actuation system, and a gas-driven actuation system.

According to a further embodiment of the present invention there is disclosed a method of transforming an aircraft, the method comprising providing a system for transforming an aircraft and operating the gimballed RLD assembly by way of the RLD control system. The transforming system comprises providing a RLD assembly, the RLD assembly comprising providing at least one concentric RLD hub plenum and support assembly providing at least one RLD rotatably and lockably coupled with at least one corresponding concentric RLD hub plenum and support assembly, and providing at least one of at least one RLD pivotally and lockably coupled with each at least one corresponding RLD plenum and support assembly, the at least one of each RLD comprising a leading edge and a trailing edge, the leading edge substantially symmetric in relation to the trailing edge, and the leading edge and the trailing edge, each, comprising an aerodynamic profile adjustment feature and providing a RLD control system operably coupled with the RLD assembly, the RLD control system providing comprising configuring the RLD control system to: selectively control angular velocity of the at least one RLD, at least one of selectively lock and selectively unlock the at least one RLD, selectively reorient at least one of each RLD in relation to the at least one corresponding RLD plenum and support assembly, selectively adjust the aerodynamic profile of at least one of the leading edge and the trailing edge and upper surface; and at least one of selectively lock and selectively unlock at least one of each RLD in relation to the at least one corresponding RLD, whereby the at least one of each RLD is respectively configurable as a wing for transforming the aircraft. Operating the gimballed RLD assembly by way of the RLD control system comprises performing at least one of selectively controlling angular velocity of the at least one RLD, selectively reorient at least one of each RLD in relation to the at least one corresponding RLD plenum and support assembly, selectively adjusting at least one of the adjustable leading edges and the adjustable trailing edge and upper surfaces; and at least one of selectively locking and selectively unlocking the at least one of each RLD in relation to the at least one corresponding RLD plenum and support assembly thereby respectively configuring at least one of each RLD as a wing, and thereby transforming the aircraft. The method may further comprise transitioning from vertical take-off to hovering, and from hovering to fast forward flight.

According to a further embodiment of the present invention there is disclosed an aircraft fuselage comprising a contoured shaped upper surface configured to reduce the effect of downwash of the RLD and a contour shaped ridge, oriented forward to aft, for keeping air attached to a surface of the fuselage during forward flight.

According to a further embodiment of the present invention there is disclosed an aircraft comprising a first concentric RLD hub plenum and support assembly a first RLD coupled to the first concentric RLD hub plenum and support assembly, a second concentric RLD hub plenum and support assembly concentric with the first concentric RLD hub plenum and support assembly and a second RLD coupled to the second concentric RLD hub plenum and support assembly whereby the first and second RLDs are operable independently.

The first and second RLDs may be lockable together. The first and second RLDs may be lockable together in variable positions. The aircraft may further comprise a third concentric RLD hub plenum and support assembly concentric with the first concentric RLD hub plenum and support assembly and a third RLD coupled to the third concentric RLD hub plenum and support assembly, whereby the first, second and third RLDs are operable independently.

The first, second and third RLDs are may be lockable together. The first, second and third RLDs may be lockable together in variable positions. An angle of the first and second RLDs with respect to a fuselage may be reconfigured to oblique positions to reduce drag at high speed. The first and second RLDs may be locked in a stacked parallel arrangement. The first and second RLDs may be locked in a stacked parallel arrangement perpendicular to a fuselage.

According to a further embodiment of the present invention there is disclosed a a transformable main wing control system comprising a flap configured to be fully retractable into a wing such that when retracted the wing has a clean undisturbed shape.

The aircraft may further comprise a hinged wing flap interface vane configured to open and close as the flap extends out from and into the wing. The aircraft may further comprise a seal for closing the wing with the flap inside and for keeping an airtight seal between the wing and the flap with the flap partially or fully extended. The aircraft may further comprise an airflow enhancement device configured to be fully retractable into the wing when the flap is fully retracted and configured to direct airflow over the flap when the flap is fully extended.

According to a further embodiment of the present invention there is disclosed an aircraft comprising a pair of transformable main wings, a canard and an empennage wherein the transformable main wings, the canard, and the empennage configured to have an adjustable angle of incidence to create lift from airflow enhancement device and from downwash of RLDs.

The aircraft may further comprise the ability to progressively reduce the angle of incidence of the fixed wings, the canard, and the empennage during transition from hover to forward flight. The aircraft may further comprise positioning rudders to provide yaw control in hover mode.

According to a further embodiment of the present invention there is disclosed an aircraft comprising a first transformable main wing coupled to a fuselage, a second transformable main wing coupled to the fuselage, a first fan on first transformable main wing and a second fan on the second transformable main wing wherein the first and second fans configured to add vertical and forward thrust and as well as to provide attitude control to the aircraft.

The first and second fans may comprise vector vanes configured to provide articulated control to improve thrust vectoring capability and laminar flow enhancement capability. The first and second fans may assist in adjusting an angle of incidence of the first and second main wings. According to a further embodiment of the present invention there is disclosed a transformable main wing system comprising: a laminar flow enhancement device fully retractable into and out of a first slot, the laminar flow enhancement device directing airflow across a top surface of a wing.

The transformable main wing system may further comprise a pressurized gas supply to the laminar flow enhancement device that delivers pressurized gas to a forward tip of the laminar flow enhancement device. The pressurized gas may be expelled from top and bottom apertures of the forward tip of the laminar flow enhancement device such that in forward motion airflow is directed across the top surface of the wing. The laminar flow enhancement device may be shaped as an airfoil with a larger front end and a tapered tail end. The laminar flow enhancement device may be rotated down into an upper slot to reduce drag at high speeds. The first and second fans may be fully retractable into the first and second transformable main wing s respectively to reduce drag at moderate to high speeds.

According to a further embodiment of the present invention there is disclosed an RLD system comprising a RLD having first and second end tips, the RLD having first and second edges and first and second tip vortex inhibiting vane nozzles proximal to the first and second RLD end tip. The RLD system may further comprise first and second rotatable thrust nozzles at the first and second end tips.

According to a further embodiment of the present invention there is disclosed a method of changing an attitude of an aircraft comprising modulating valves of the RLD thereby modifying the lifting effect of the RLD. The RLD system may further comprise nozzles at the first and second edges, the nozzles configured to selectively provide a stream of supplied air or a sheet of supplied air. The nozzles may provide the ability to reorient the first and second edges. Selectively providing the stream of supplied air or the sheet of supplied air may be actuated by selecting a different air supply to the nozzles. The nozzles may be retractable into the RLD. The retracted nozzles may result in a sheet patterned airflow on a trailing edge. An RLD system may further comprise a bi-directional laminar flow enhancement nozzle configured to redirect airflow towards whichever of the first and second edges is the trailing edge.

According to a further embodiment of the present invention there is disclosed an RLD system comprising an air supply, a first hub plenum and support assembly connected to the air supply and a first RLD coupled to the first hub plenum and support assembly. The RLD system may further comprise a second hub plenum and support assembly concentric to the first hub plenum and support assembly, the second hub plenum and support assembly connected to the air supply and a second RLD coupled to the second hub plenum and support assembly.

The first and second RLDs may be lockable together at any angle between perpendicular and parallel to the fuselage. The first and second RLDs may be continuous span tapered airfoils. The first and second RLDs may have airflow enhancement devices to improve the lifting capability and to be transitionable to high speed wings. The first and second RLDs may be readily interchangeable with other RLDs, whether of a same or different shape. The first and second RLDs may have an undulating shape on a first edge, a second edge, a top surface and a bottom surface.

The RLD system may further comprise a third hub plenum and support assembly concentric to the first hub plenum and support assembly, the third hub plenum and support assembly connected to the air supply and a third RLD coupled to the third hub plenum and support assembly.

According to a further embodiment of the present invention there is disclosed transformable main wing control system comprising: a two stage flaperon configured to be retractable into a wing such that at a first stage a small extendable first flaperon is extended, and that at a second stage a large extendable second flaperon is extended.

Other aspects and features of the present invention will become apparent to those ordinarily skilled in the art upon review of the following description of specific embodiments of the invention in conjunction with the accompanying figures.

### BRIEF DESCRIPTION OF DRAWINGS

In figures which illustrates aspects of non-limiting embodiments of the invention:

FIG. 1A is a plan view of an embodiment of the invention, shown without a RLD;

FIG. 1B is a cut-away enlarged portion of the plan view of FIG. 1A;

FIG. 2 is a plan view of the embodiment of FIG. 1A shown with a RLD;

FIG. 3 is a plan view of the embodiment of FIG. 1A shown with two RLDs;

FIG. 4A is a plan view of the embodiment of FIG. 3 with the RLDs in an alternate oblique orientation

FIGS. 4B through 4H show enlarged features of FIG. 4A.

FIG. 5 is a front view of the embodiment of FIG. 3 with the RLDs reoriented/rotated by 45 degrees;

FIG. 5A is a cross-sectional view of FIG. 5 along line A-A.

FIG. 5B is a magnified view of the rotatable bidirectional thrust nozzle and two stage extendible retractable Flaperon integrated with flaps.

FIG. 6 is a rear view of the embodiment of FIG. 5;

FIG. 7A is a front view of the embodiment of FIG. 5 with the lower RLD re-oriented parallel to the top RLD and locked into thereto;

FIGS. 7B, 7C and 7D show enlarged portions of FIG. 7A for magnification purposes and showing a locking device in operation;

FIG. 8A is a right side view of the embodiment of FIG. 5 showing a cross-sectional view of the near transformable wing;

FIG. 8B is a left side view of the embodiment of FIG. 5 showing a cross-sectional view of the near transformable wing;

FIG. 9A is a right side view of the embodiment of FIG. 8A with the orientation of various moving parts adjusted;

FIGS. 9B, 9C and 9D show an enlarged portion of FIG. 9A for magnification purposes and showing retractable flaps and laminar flow enhancement devices in operation;

FIG. 9E is an enlarged cut-away portion of FIG. 9A for magnification purposes and showing the orientation of the elevators and horizontal stabilizer;

FIGS. 9F and 9G show an enlarged portion of FIG. 9B.

FIG. 9H is a detailed cross sectional view of the transformable main wing locking device.

FIG. 10A is a right side view of the embodiment of FIG. 9A with the transformable main wing apparatus shown.

FIGS. 10B and 10C, 10D, 10E, and 10F show enlarged portions of FIG. 10A;

FIG. 10D is an enlarged cut-away portion of FIG. 10A; FIGS. 10E and 10F show enlarged portions of FIGS. 10B and/or 10C;

FIG. 11 is a right side view of the embodiment of FIG. 8A with the RLDs, transformable main wings and landing gear in alternate positions;

FIG. 11A is an enlarged cut-away portion of FIG. 11;

FIG. 11B is an enlarged portion of FIG. 11 showing a laser guided ship tethering and landing system.

FIG. 12 is a right side view of the embodiment of FIG. 11 with the RLDs, transformable main wings and landing gear in alternate positions;

FIG. 12A is an enlarged cut-away portion of FIG. 12;

FIG. 13 is a right side view of the embodiment of FIG. 12 with the RLDs in alternate positions;

FIG. 13A is an enlarged cut-away portion of FIG. 13;

FIG. 13B is an enlarged portion of FIG. 13;

FIG. 13C shows an alternate position for the ducted fan of FIG. 13B;

FIG. 14 shows an optional drone launch and capture apparatus at the rear of the embodiment of FIG. 13;

FIG. 15A is a cross-sectional schematic plan view of a RLD in accordance with an embodiment of the invention;

FIGS. 15B and 15C show enlarged detailed portions of FIG. 15A;

FIG. 16 is a cross-sectional schematic plan view of a RLD in accordance with an embodiment of the invention showing the adjustable RLD weight system;

FIG. 17A is a cross-sectional schematic plan view of a RLD in accordance with an embodiment of the invention;

FIGS. 17B, 17C and 17D show enlarged portions of FIG. 17A;

FIG. 18 is a plan view of a RLD in accordance with an embodiment of the invention;

FIG. 19 is a cut-away plan view of a RLD surface in accordance with an embodiment of the invention, at a mid-span section;

FIG. 20 is a cross-sectional side view of the RLD of FIG. 18 taken along the line 20-20 of FIG. 18;

FIG. 21 is a plan view of a RLD showing air flow enhancement nozzles in accordance with an embodiment of the invention;

FIG. 22A is a cross-sectional schematic side view of a RLD as shown in FIG. 21, at an inboard cross-section;

FIG. 22B is a detailed view of a combination sheet/stream nozzle in a leading-edge configuration;

FIG. 22C is a detailed view of a combination sheet/stream nozzle in a trailing-edge configuration;

FIG. 22D is a detailed plan view of a combination sheet/stream nozzle as taken along the line 22D-22D of FIG. 22A;

FIG. 23A is a cross-sectional schematic side view of a RLD surface in accordance with an embodiment of the invention, as taken along the line 23A-23A in FIG. 21, at a near-inboard cross-section;

FIGS. 23B and 23C show portions of the view of FIG. 23A from alternate angles;

FIG. 24 is a cross-sectional schematic side view of a RLD as taken along the line 24-24 in FIG. 21, at the near-tip cross-section;

FIG. 25 is a cross-sectional side view of a RLD shaft and RLD arrangement for transporting gas flow in accordance with an embodiment of the invention;

FIG. 26A is a perspective view of two RLDs in accordance with an embodiment of the invention;

FIG. 26B is an enlarged cut-away portion of FIG. 26A;

FIG. 27A is top plan view of the embodiment of FIG. 1;

FIG. 27B is a plan view of an enlarged portion of FIG. 27A illustrating repositioning of a ducted fan;

FIGS. 27C, 27D, and 27E are enlarged cut-away plan views of portions of

FIG. 27A showing repositioning of an auxiliary lifting device;

FIG. 28A is a right side view of the embodiment of FIG. 9A with the RLDs in an alternate position;

FIGS. 28B and 28C are enlarged side views of portions of FIG. 28A showing repositioning of a ducted fan;

FIG. 29A is a perspective view of a ducted fan in accordance with an embodiment of the invention;

FIG. 29B is a perspective view of a cross-section of the ducted fan shrouds of FIG. 29A to show reference locator D-D and E-E;

FIG. 29C is a cross-sectional perspective view of the ducted fan shrouds of FIG. 29B;

FIGS. 29D and 29E are cross-sectional perspective views taken along lines D-D and E-E of FIG. 29B.

FIG. 29F is the ducted fan of FIG. 29A in an almost fully extended mode.

FIG. 30A is a close-up perspective view of a locking device as shown in FIG. 25;

FIG. 30B is a close-up plan view of the locking device of FIG. 30A;

FIG. 31 is a cut-away plan view of an embodiment in accordance with an embodiment of the invention showing a rotatable ordinance/sensor rail;

FIGS. 31A and 31B are enlarged side views of portions of FIG. 31 showing repositioning of the rotatable ordinance/sensor rail and its payload into and out of the fuselage;

FIG. 32 is a plan view of the embodiment of FIG. 1A showing airflow enhancement compressed air supply;

FIG. 33 is a cut-away plan view of the embodiment of FIG. 1A showing function control compressed air supply;

FIG. 34A is a plan view of an alternate embodiment of the invention having a non-linear leading edge and trailing edge with upper and lower surface contours configurations for the RLDs;

FIGS. 34B, 34C, and 34D are enlarged views of portions of the embodiment of FIG. 34A;

FIG. 35A is a plan view of an alternate embodiment of the invention having differently configured linear leading edge and trailing edge configurations for the RLDs;

FIGS. 35B and 35C are enlarged views of portions of the embodiment of FIG. 35A;

FIG. 35D is a cross-sectional view of the lift disc adjustment devices.

FIG. 36 is a perspective view of two RLDs as shown in FIG. 3;

FIG. 37A is a perspective view a RLD system, in accordance with an embodiment of the invention, having a linear edged RLD and a non-linear edged RLD;

FIGS. 37B, 37C and 37D are enlarged views showing rotation and angular transformation of the outer sections of a RLD of FIG. 37A;

FIGS. 37E and 37F are cross-sectional views of the transformable RLD section adjustment mechanism.

FIGS. 38A and 38B is a perspective view showing the stacking of multiple RLDs on a RLD shaft, in accordance with an embodiment of the invention;

FIG. 39A is a plan view of the embodiment of FIG. 1A illustrating operation of certain control surfaces;

FIG. 38B is an enlarged view of the divided RLD root connection shroud;

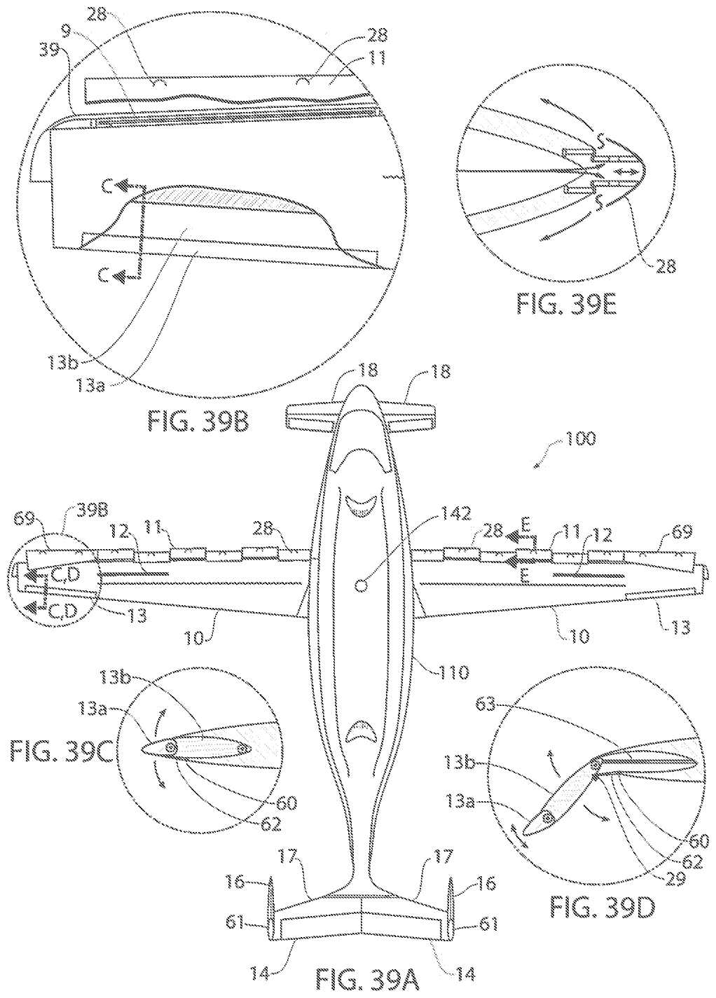

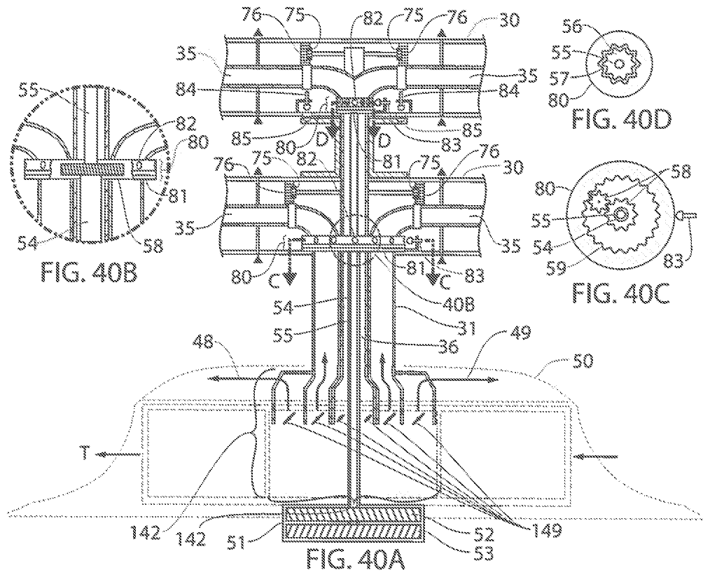

FIGS. 39C, 39D and 39E are enlarged views of the embodiment of FIG. 39A;

FIG. 40A is a cross-sectional side view of a RLD shaft and RLD arrangement in an alternate of embodiment of the invention;

FIGS. 40B, 40C and 40D are enlarged views of the embodiment of FIG. 40A.

| Acronym | Meaning |
|---|---|
| AIE | airflow inducement/entrainment |
| AIED | airflow inducement & entrainment device |
| AOI | angle of incidence |
| APU | auxiliary power unit |
| CEVSTOL | cruise-efficient vertical and short take-off and landing |
| RLD | rotational lifting device |
| UAV | unmanned aerial vehicle |
| VTOL | vertical take-off and landing |

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense. As utilized herein the following acronyms will have the following meaning:

| Acronym | Meaning |
|---|---|
| AIE | airflow inducement/entrainment |
| AIED | airflow inducement & entrainment device |
| AOI | angle of incidence |
| APU | auxiliary power unit |
| CEVSTOL | cruise-efficient vertical and short take-off and landing |
| RLD | rotational lifting device |
| UAV | unmanned aerial vehicle |
| VTOL | vertical take-off and landing |

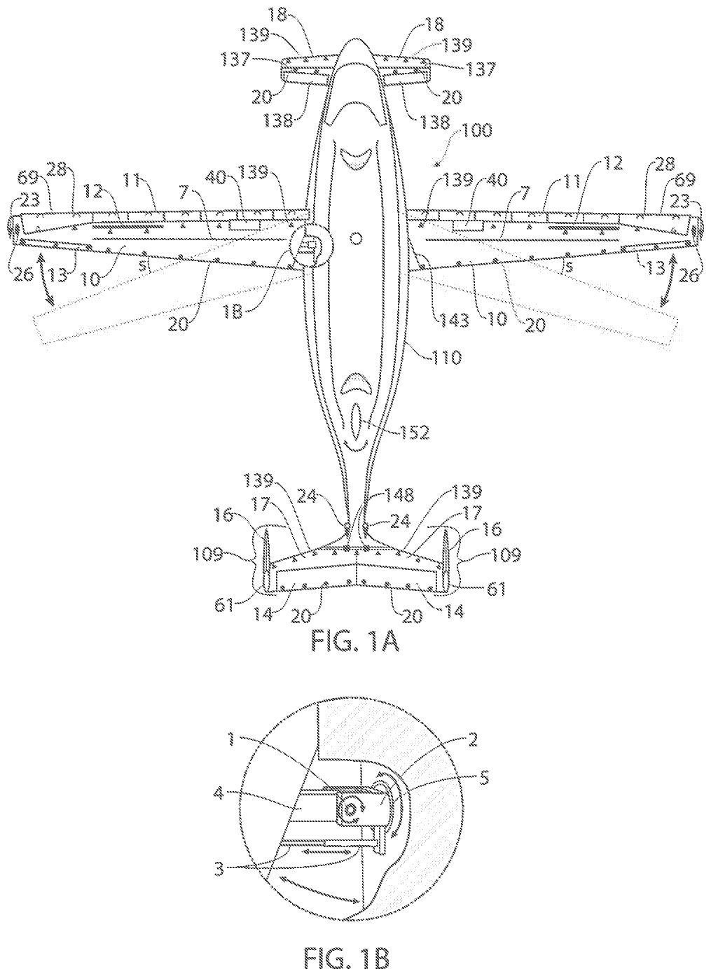

FIG. 1A is the starting point of the invention in that it is the airplane portion only of the aircraft 100 without any rotating lifting devices (RLD). It should be known that the aircraft as shown, is a totally viable short take-off and landing aircraft. It is also a viable high-speed aircraft. These dual capabilities are made possible by the optional transformable main wing 10, which can be rearranged from a long cord low aspect wing, using various lift and airflow enhancements for low speed flight, to a clean short cord high aspect ratio swept wing for high speed flight, as referenced by the dotted lines.

The various laminar flow enhancement devices, in conjunction with airflow inducement and entrainment devices such as the sheet nozzles 20, the split stream nozzles 28, the combination upper sheet/lower stream nozzles 139, and the airflow inducement and entrainment (AIE) slots 7 depicted here as well as the angle of incidence adjustable canards 18 and transformable main wings 10, and empennage 109 provide the ability for the aircraft to fly in full control at very low speeds. This capability is further enhanced by the tip vortex inhibit vane nozzles 26. When all of the low speed enhancement features are retracted or turned off, and the wings are adjusted into the swept mode, the aircraft is capable of flying at very high speeds. If desired for operational concerns, a less complex lighter weight non transformable wing can be installed without requiring any modifications to the airplane.

Also shown in FIG. 1A are the Canard Ordinance/Sensor Attachment Rail 137, the Canard AOI Adjustment Tab 138, the ducted fans 40, the interceptor/spoilers 12, the automatic pressure activated slats 11, the adjustable leading edge sweep slat 69, the two-stage extendable/retractable flaperons 13 the Main Wing Sweep Streamlining Shroud 143, between the transformable main wing 10 and the fuselage 110, the Engine Exhaust Influenced Retractable Yaw Control Augmentation Vane 152, the empennage 109, consisting of: the Empennage AOI Adjustment Control 148, the horizontal stabilizer 17, the elevators 14, the rudders 61, and the vertical stabilizers 16. Additionally, seen are the rotatable bidirectional thrust nozzles 23, the (aft) yaw thrust nozzles 24, and the sheet nozzles 20.

FIG. 1B depicts the device used to adjust the angle of incidence and sweep of the wing, using the main wing adjustment hinge pin 1, the main wing fuselage attachment flange 2, the main wing sweep servo 3, the main wing attachment flange 4, the main wing fuselage angle of incidence (AOI) rotation bearing 5. It is also the point at which other types of wing, such as a less complex standard performance or a high aspect ratio wings can be attached. It is noteworthy that this interchangeability of wings can be accomplished without any structural change to the aircraft.

As shown in FIG. 1B the main wing adjustment hinge pin 1 holds the main wing fuselage attachment flange 2, together with the main wing attachment flange 4. The wing is rotatable at the main wing fuselage adjustable angle of incidence rotation bearing 5. A main wing seep servo 3 is also attached between the wing and the fuselage as shown in FIG. 1B.

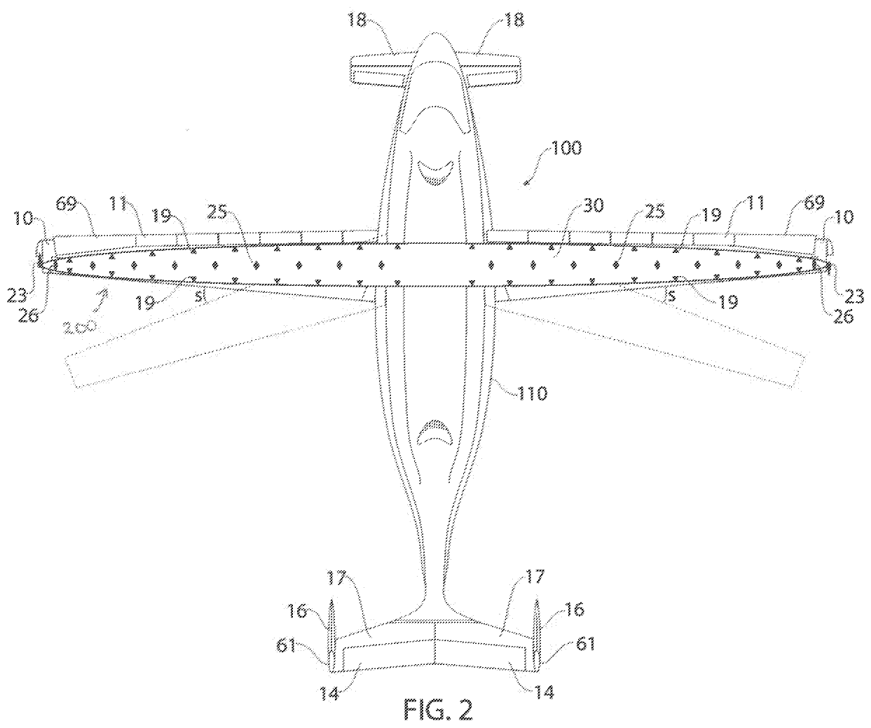

FIG. 2 represents the attachment of one type of RLD (rotational lifting device) to the aircraft, which would enable vertical take-off and landing. Various airflow enhancement devices are depicted on the RLD 200, such as multi-functional, bidirectional, combination sheet/stream nozzle 19, and bidirectional laminar flow enhancement nozzles 25, which improve the laminar flow and the boundary layer adhesion, as well as providing for attitude control of the lifting disk, while reducing drag. Also shown are tip vortex inhibit vane nozzles 26 which inhibit tip vortex formation and its resultant drag. Additionally The rotatable bidirectional thrust nozzles 23 are shown, which provide the rotational motive force in this embodiment, as well as thrust augmentation.

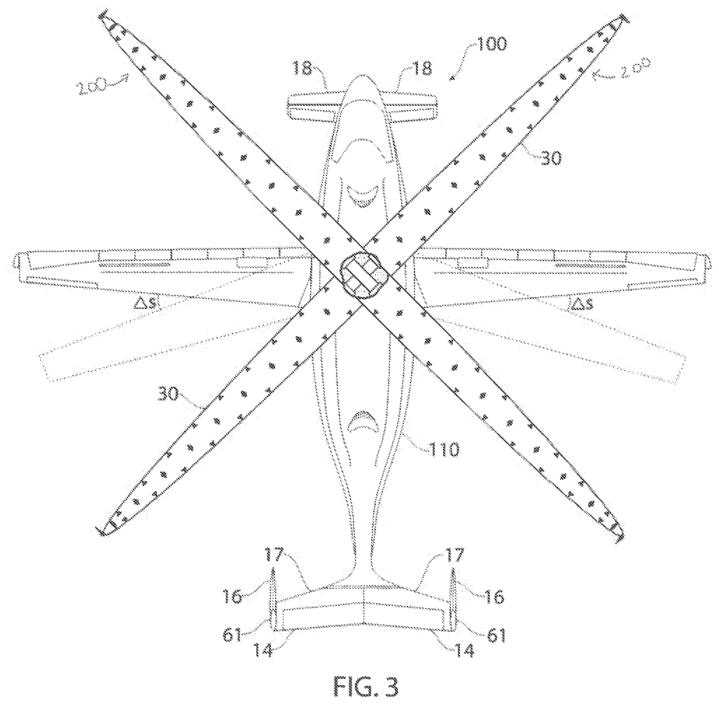

An optional arrangement of two independent rigid/semi rigid rotational lifting devices “RLD” 200 is shown in FIG. 3, with one above the other. In this case the RLDs have been coupled together in a 90° offset to provide additional lift and control. As utilized herein, the term rotating lifting device is utilized to refer to a body which is rotatable relative to the aircraft to provide lift. It will be appreciated that in conventional helicopters, such a device is commonly referred to as a rotor having at least two blades extending from a common vertical shaft or pivot. In the present application, as will be further described below, the RLD 200 may be configured to perform similar lifting functions as a helicopter rotor as well as configured stationary to perform similar lifting functions as a wing. The RLD 200 is formed of a pair of RLD segments 30 which as illustrated herein are formed to extend in opposite directions from a central rotary support. The RLD segments 30 may be controlled independently of each other to permit the RLD 200 to be utilized as a rotor for creating vertical lift or as a wing for horizontal flight.

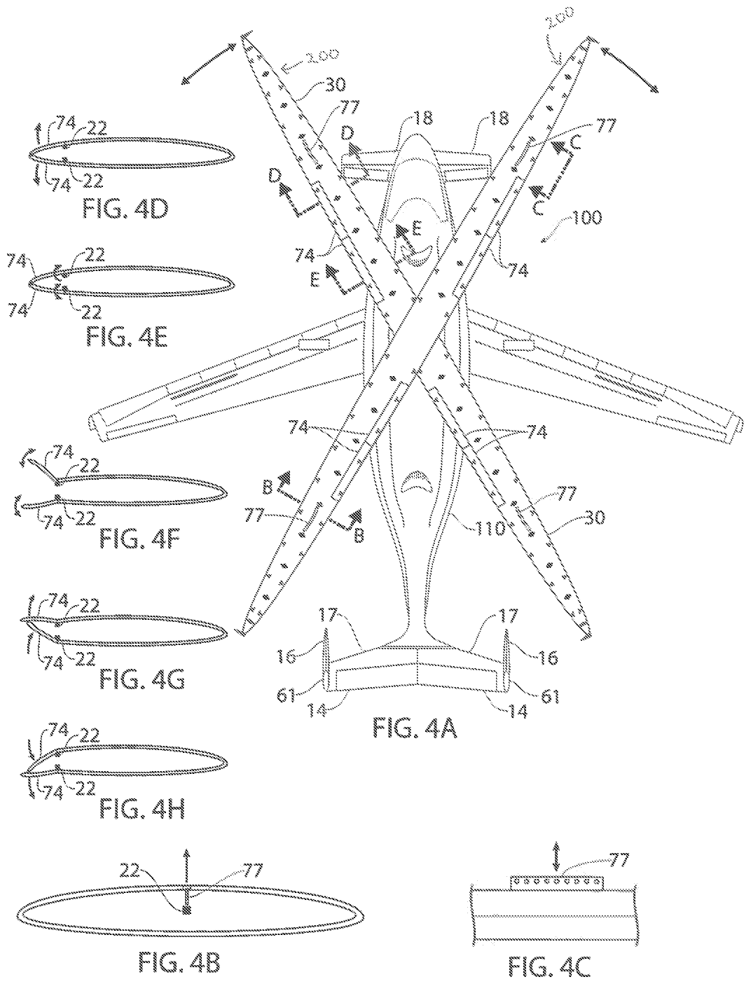

FIG. 4A depicts two independently operated rotational lifting devices, locked in a fixed, swept or oblique arrangement, in order to provide less Drag at high speed. The devices are able to be independently adjusted and locked at any angle. The advantage of this feature allows for the devices to be positioned in the most favorable angle for the particular speed desired. This figure also depicts the location of the multifunctional coincidentally or independently operated oblique stability control vane 74 and the oblique stability control interceptor 77.

FIGS. 4B through 4H show the various flight controls, used in conjunction with the nozzles, to affect the attitude and stability of the RLD 200, primarily in oblique orientations

FIG. 4B depicts a cross-section shown as B-B on FIG. 4A, representing the modulating valve 22 for the retracted oblique stability control interceptor 77, which is further shown on:

FIG. 4C depicts a cross-section C-C on FIG. 4A representing the extended oblique stability control interceptor 77 FIGS. 4D, 4E, 4F, 4G, & 4H depict cross-sections of FIG. 4A at D-D & E-E, representing the various deployment options of the multifunctional coincidentally or independently operated oblique stability control vanes 74

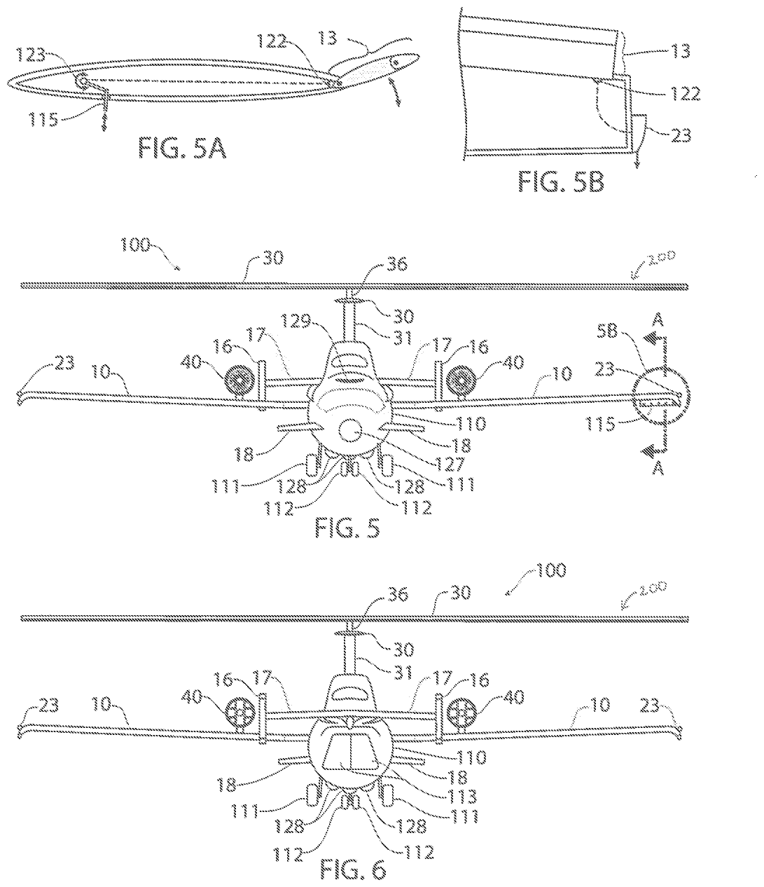

FIG. 5 shows the aircraft 100 in a static front view with the optional RLD 200 in a 90° offset configuration, and with various features of the embodiment apparent, such as: The rotor system mid plenum/upper RLD support assembly 36, the outer plenum/lower RLD support assembly 31, the upper forward sensor rail 129, the horizontal stabilizer 17, the vertical stabilizers 16, the ducted fan, attitude control assist, vectored thrust, laminar flow enhancement device 40, transformable main wing 10, adjustable angle of incidence canards 18, rotatable bidirectional thrust nozzles 23, and adverse yaw correction vane 115. Also shown are the retractable main landing gear 111, retractable nose landing gear 112, nose sensor turret 127, retractable lower sensor turrets 128 which are attached to the fuselage 110.

STOL aircraft, which have highlift wings, tend to initially turn (or in aviation terms—yaw) in the opposite direction to that which is requested by banking the wings; when flying at slow speeds. In other words when a pilot banks the airplane left wing down to create a left turn, the highlift wing design tends to be drawn into a right yaw because of large aileron deflection downwards required on the right (high)wing during slow speed manoeuvres. To correct the adverse yaw in these circumstances, this embodiment employees the use of an adverse yaw correction vane 115 and thrust nozzle 23 that are interconnected with the {aileron}, in this case—flaperon 13 control. When a large flaperon deflection is initiated and detected by the position/rate sensor 122, Vane Drive 123 rotates the vane 115 to extend from the lower wing surface, and the thrust nozzle 23 is modulated and directed forwards on the lower wing to correspondingly increase drag. Conversely, the higher side transformable main wing thrust nozzle is programmed to create forward thrust; thereby overcoming the tendency of adverse yaw. When the degree of Flaperon deflection and rate is decreased below the prescribed threshold, the metered Vane and Nozzle control inputs are cancelled. This system, which uses a downward, or below wing, vane extension is preferable to a system that would employ an upward or upper surface extension because this system increases drag but does not decrease lift to the degree that an upper wing surface airflow intrusion would. Additionally, the use of the thrust nozzle in this embodiment requires less surface extension to realize the adverse yaw correction, thereby resulting in a more balanced lift and control situation. This system is also integrated with the interceptor/spoiler 12 control system, as further depicted and described at FIG. 39A. The embodiments in this system support the manoeuvrability required to transition to and from a forward—fixed wing mode at low speed to enable the transformation of the aircraft.

FIG. 5A depicts a cross-section A-A from FIG. 5 representing the interaction between the adverse yaw correction vane 115 powered by the Adverse Yaw Correction Vane Drive 123 controlled by the flaperon angle and rate sensor/interface to thrust nozzle and adverse yaw vane 122, and the flaperons 13 integrated with the flaps 15 [which are further shown and depicted in FIG. 39A,B,C,D]

FIG. 5B depicts the interaction between the rotatable bidirectional trust nozzle 23 and the flaperons 13, integrated with the flaps 15, controlled by the flaperon angle and rate sensor/interface 122 to thrust nozzle and adverse yaw vane 115.

FIG. 6 shows the same aircraft and condition as FIG. 5 from a rear view perspective, additionally showing the rear hatch door 113 and the vane components of 40

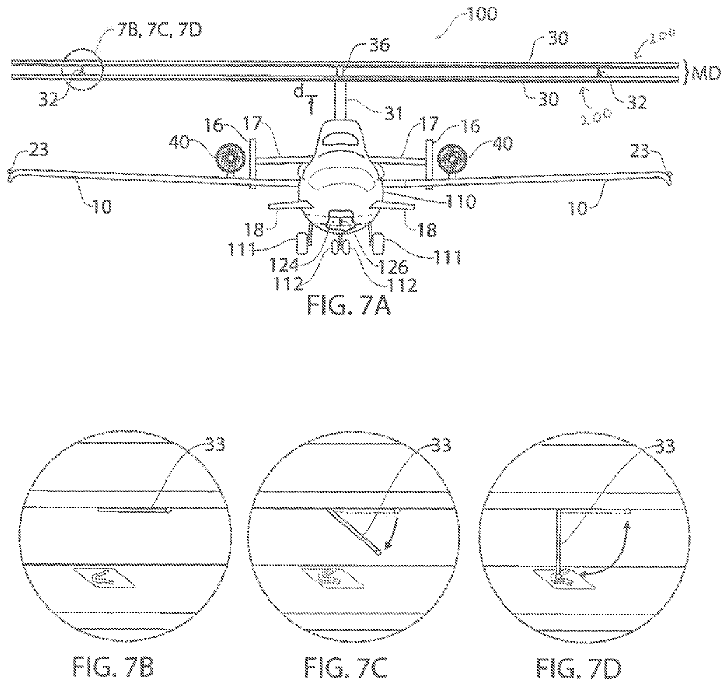

FIG. 7A shows the same embodiment and static condition as FIG. 5, with the addition of the depiction of the two RLD 200, oriented and parked in a position perpendicular to the fuselage to perform as high aspect ratio wings. The devices are vertically locked together by the RLD park coupling lock mechanism 32 to prevent contact and to provide additional strength for Cruise mode. Also showing here, in a cutaway view, are the bidirectional yaw trust tunnel 124 and the bidirectional electric yaw thrust fan 126.

FIGS. 7B, 7C, 7D depict the vertical locking arrangement of the rotational lifting devices, using the RLD park rotational engagement strut 33

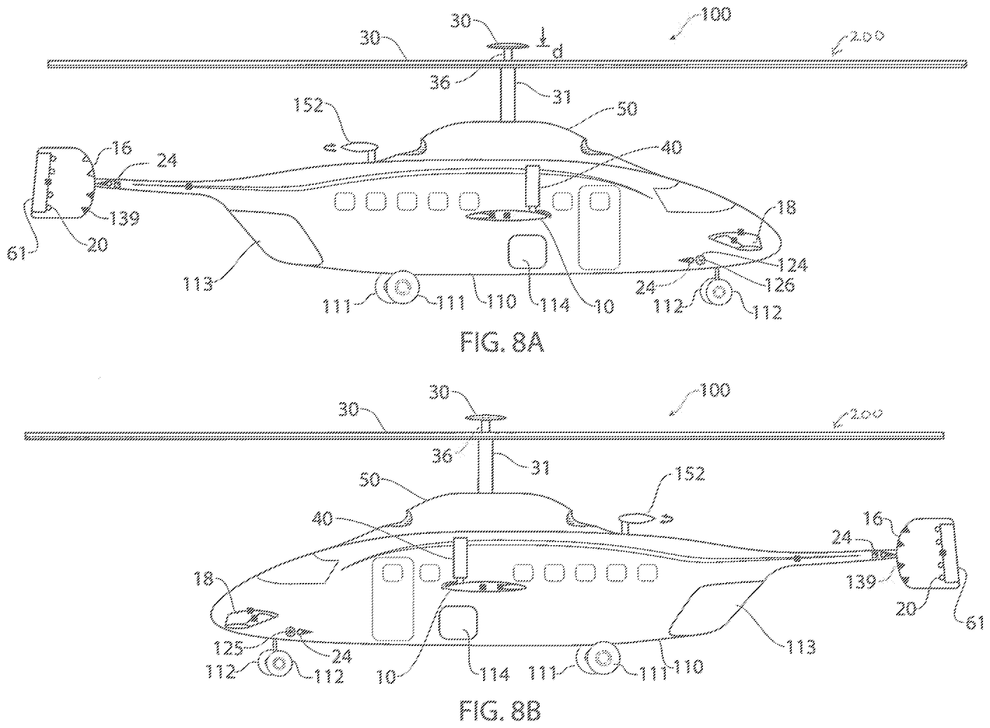

FIGS. 8A and 8B are representative of the aircraft, from a right and left perspective, in a static pre-operative condition depicting various features as they are oriented prior to engine start, such as . . . RLD 200 locked in a 90° offset, the vertical stabilizer 16, the transformable main wings 10, and the adjustable canard 18 are all shown in neutral angle of incidence{AOI}. The retractable Yaw Control Augmentation Vane 152 is extended into the engine exhaust stream area. This placement provides additional control and power for Yaw management even when at Zero forward speed. Harnessing The power of the exhaust stream results in additional power available for Yaw control when additional power and torque is added from the engine. This is of particular merit when used in the mechanical RLD powered embodiment and doesn't require complicated antitorque tail rotor systems which use additional power.

Also depicted here are the Bidirectional Electric Yaw thrust Tunnel 124, the Bidirectional Electric Yaw Thrust Fan 126 within the tunnel on FIG. 8A, while FIG. 8B shows the Iris Vane cover for Electric Yaw Thrust Tunnel 125 closed. Additionally, the pneumatic yaw thrust nozzles 24 is shown on each side of the fuselage 110 near the tunnel and also just forward of the vertical stabilizer 16. The rear hatch doors 113 are indicated in the closed position. As well, the first reference of the ordinance rail hatch 114 is depicted on each side of the fuselage.

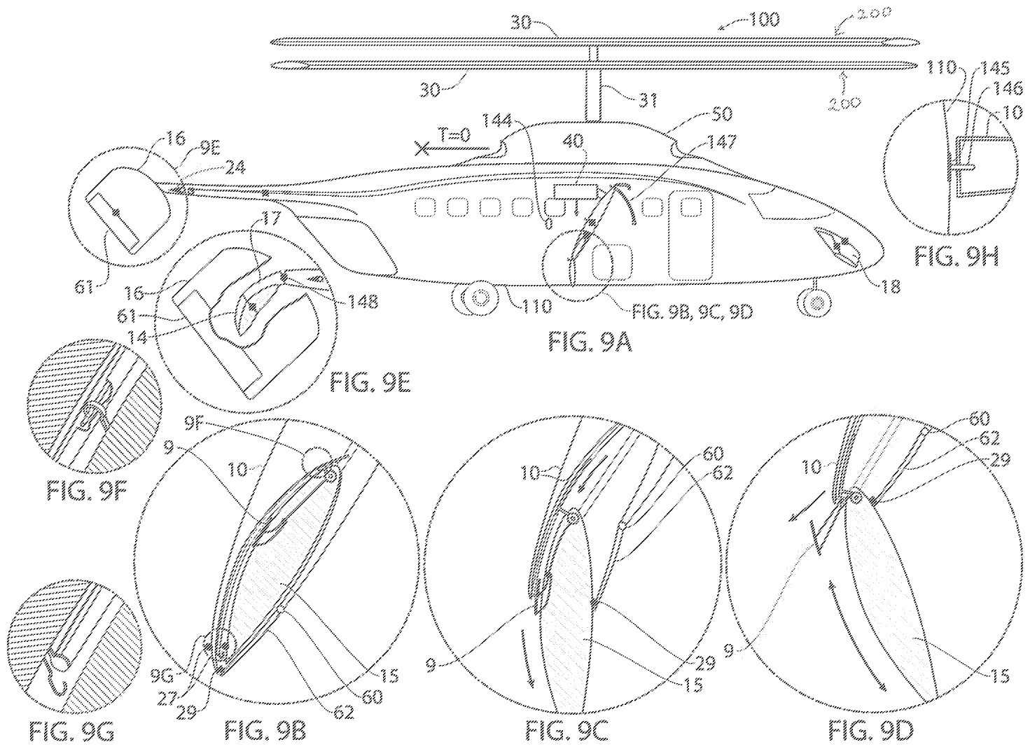

FIG. 9A shows the aircraft from the right slide view, in a powered initial take-off condition, with the rotational lifting devices rotating and locked in a 90° offset. The engines are running and producing compressed air, although not producing forward thrust. The transformable wing 10 and empennage (14,16,17,61) FIG. 9E are adjusted into the maximum angle of incidence position, while the canard 18 has a negative angle of incidence, so that all of these surfaces including the rudders 61 are able to produce lift and/or control from the downwash effect of the rotational lifting devices and minimize the pressure supplied to the upper surfaces that would result if they were left in neutral angle of incidence

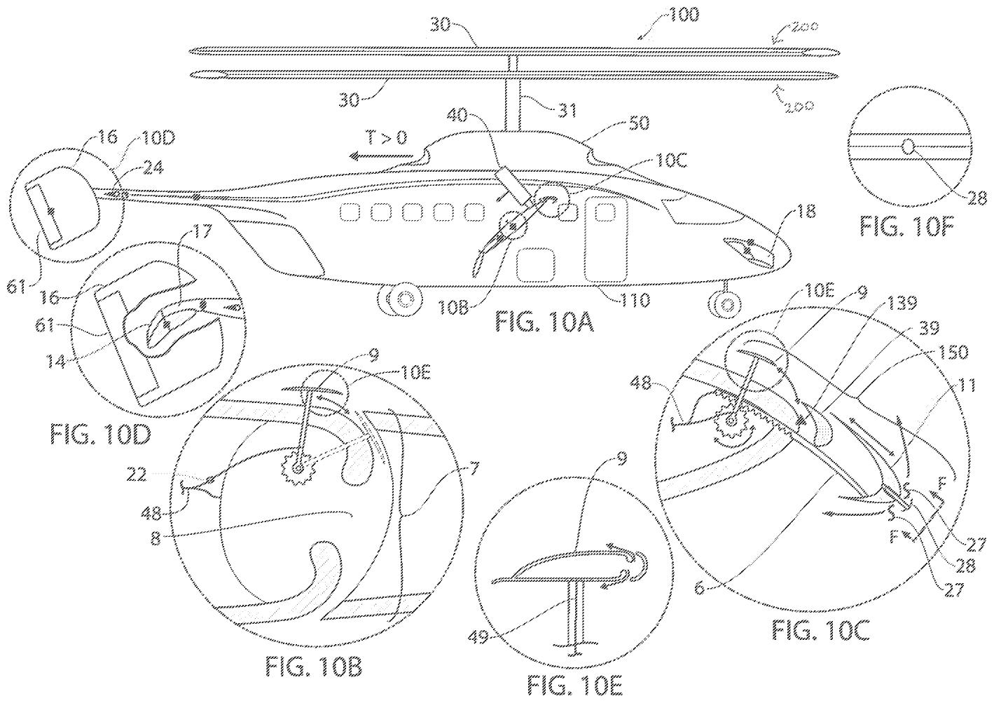

All of the lift enhancement devices, including those more particularly represented and described in FIG. 10A,B,C,D,E,&F are deployed. Also the ducted fan 40 is in its maximum extension, which provides attitude control assistance, additional lift, vectored thrust, and enhanced laminar flow on the wing. The flaps 15, together with the rotatable extendable airflow inducement and entrainment device (AIED) 9 are also fully extended as shown in the sequence FIGS. 9B, C, & D. The stream nozzles 27 as shown in FIG. 9B on the transformable main Wing and Flap trailing edge are fully powered to enhance airflow and aid in boundary layer attachment. FIG. 9G depicts the auto deployment hook for AIED 9.

The flaps are unique in that by being fully retractable, it has the effect of altering the cord of the Wing from narrow at times of high speed to wide at times of low speed. Beyond that benefit, the retractability also ensures smooth wing surfaces, and present a non-cluttered shape into the airflow when extended on their attachment rails within the wing (FIG. 9F); creating less turbulence than hinged flaps. This results in greater lift with less drag. The smooth angular transition between the lower surfaces, created by the flap/wing interface seal 29, as shown in FIGS. 9 B,C &D results in a greater underwing pressure.

The extendable AIED 9, as shown in FIGS. 9B,C,D,& 10B,C,E is effective in two ways. The air blown from within its upper and lower surfaces, as shown in FIG. 10E, causes a greater airflow over the rear portion of the wing, which together with the stream nozzles 27 at the trailing edges of the transformable main wing 10 and flap 15 results in improved airflow and less turbulence. The extension of the airfoil shape of the extendable AIED 9 into the airflow above the boundary layer, assists in keeping the boundary layer following the curvature of the flap surface. It is noteworthy that the extension of the AIED 9, on the flap, does not require any further control device as it is deployed and retracted automatically with the extension of the flap by engaging with the capture hook FIG. 9G. These many factors combine to create greater lift and less drag, which results in a reduced airfoil stall speed and greater controllability at slow speed. By achieving lift and control at low speed with the wing, the rotational lifting devices can more readily be parked and configured as wings, permitting rapid acceleration of the aircraft without concern for the problems of retreating blade stall and high tip speed instability, associated with typical rotary wing aircraft.

FIG. 9H depicts the wing stabilizer flange 145 that is engaged to the wing route stabilizer receptor 144, as depicted on FIG. 9A by the wing stabilizer flange rotatable, retractable, locking mechanism 146 when the transformable main wing 10 is parked in its neutral angle of incidence.

FIG. 10A illustrates the aircraft in an early stage of transition to forward flight. The engine is now producing some forward thrust. The ducted fan 40 has been re-oriented to be perpendicular to the cord of the transformable main wing 10 and is producing some forward vectored thrust and attitude control, while still enhancing the lift of the wing by improving the laminar flow. The angle of incidence of the transformable main wing 10, and empennage has been reduced, and the negative angle of incidence of the canard 18 has been reduced.

FIG. 10B depicts the fixed airflow inducement and entrainment slots 7, situated at the mid cord position on the wing together with their air plenum 8 in conjunction with the rotationally extendable AIED 9. By blowing compressed air, through the upper and lower AIE slots 7, more of the surrounding air is entrained and induced to follow the shape of the airfoil. As well, by extending the AIED 9, powered by the fuselage, canard, empennage, and wing airflow enhancement compressed air supply lines 48, the upper air is further induced and entrained to follow the existing airflow, and the airfoil shape of the extendable AIED 9 sitting above the boundary layer assists in keeping the boundary layer attached at the most critical point of the wing.

FIG. 10C shows the transformable main wing leading edge airflow enhancement element array 150 extended and including the automatic pressure activated slats 11, with its split stream nozzles 28, and interconnected rotatable AIED 9, supplied by 48 The secondary full span leading edge 39 is shown, which creates the full span slot behind it, where the interconnected rotatable AIED 9 is parked when retracted. Also located in the full span slot are the combination upper sheet/lower stream nozzles 139. The arrangement of these several features are to provide enhanced laminar airflow over the wing surfaces at low speed, while being able to present a clean wing leading edge when the AIED 9, and the slat 11 are retracted and covering the secondary leading edge and slot at higher speeds. The adjustability of these elements result in a wing that is an efficient high lift wing at slow speeds and has reduced drag at high speeds. In this embodiment, the AIED 9 is mechanically rotatably connected to the slat 11 extension/retraction rail and is extended and retracted coincidentally with the slat 11.

FIG. 10D depicts the adjusted angle of incidence of the elevator and horizontal stabilizer together with the vertical stabilizer and rudder (the empennage 109), during lift off and low-speed flight. While providing lift from the downwash effect of the rotational lifting devices, the increased angle of incidence also places the vertical stabilizers and rudders in a position to be able to use the down wash effect to assist the yaw thrust nozzles 24 in the yaw control of the aircraft.

FIG. 10E shows the extendable AIED 9. Which is supplied by 48 and powered by compressed air supply lines 49. This element is designed to take compressed air from the engine and express it out of the slots to blow air over the upper and lower surfaces, thereby causing surrounding air to be entrained and combined with the airflow over and under the device, while inducing the airflow to remain in close proximity to the wing surfaces. Additionally, the shape of the airfoil of the device assists in inducing the boundary layer to remain attached to the surface of the wing.

FIG. 10F depicts the raised profile of the cap of the split stream nozzle 28, situated on the leading edge of the slat 11, as depicted on FIG. 10C.

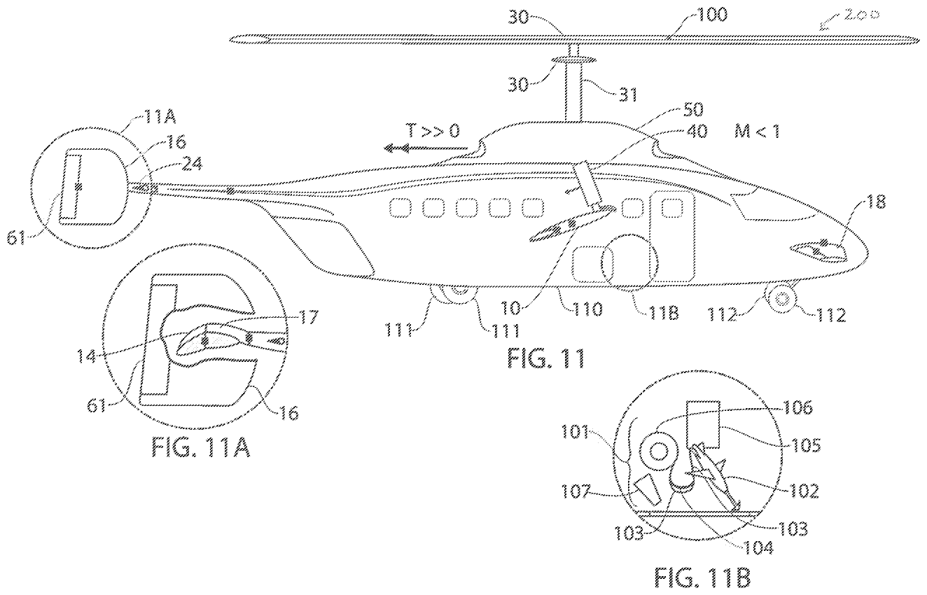

FIG. 11 illustrates the aircraft in a later stage of transition to medium speed forward flight. The engine is now producing more forward thrust, while the ducted fans 40 continue to provide forward thrust. The lower RLD has been parked in a perpendicular to the fuselage orientation and is providing lift as an auxiliary wing. The transformable main wing has continued its reduction in angle of incidence, while the leading edge, and trailing edge, lift enhancement devices, have been retracted. The empennage and canard have returned to non-adjusted angles of incidence. The undercarriage is beginning to be retracted. FIG. 11A shows that the empennage and canard has further reduced the AOI adjustment and elevator are now operating as non-adjusted flight controls.

FIG. 11B shows the laser guided ship tethering and landing system 101, employees an aerodynamically guided latching mechanism 102 which is shot from the aircraft using a compressed air accelerator 105 and follows the laser guidance 107 to deposit the latching mechanism on to the prescribed attachment point on the landing surface of a ship. The latching mechanism, with the elasticized tethering line 103 and spring line shock absorbers 104 is engaged to the hold point on the landing surface to anchor the aircraft to the ship. Taking advantage of the freewheeling rotational lifting devices, which can be separated from the other control systems of the aircraft, the rotor system is placed in the unpowered mode, while the thrust is reduced to a minimum so that the aircraft will be towed against the resistance of the rotational lifting devices at the same forward speed as the ship. The winch 106 is then used to draw the aircraft onto the ship deck. One of the main advantages of this tethering and landing system is that even though the air may be turbulent and the ship deck unstable due to rough seas, the resistance afforded by the freewheeling rotor system will allow the aircraft to mirror the attitude of the ship deck; thereby enabling a safe landing even in very adverse conditions. Another advantage of the system is that it is completely self-contained within the aircraft and does not require any specialized equipment on the ship or training of shipboard personnel, other than to provide the attachment point. This system is dramatically more valuable than the current aircraft system that requires each ship or small craft to be equipped with specialized machinery operated by specially trained personnel. The self-contained system in this embodiment, reduces the training cost for on-board ship personnel and increases the capability of the aircraft across a wide range of ships that can be provided by the aircraft and also allows the aircraft to be replenished by a variety of ships or small craft. The wide range of high speed transport, provision, surveillance, combat, and rescue capabilities of the aircraft make it ideally suited to a role of onboard ship deployment.

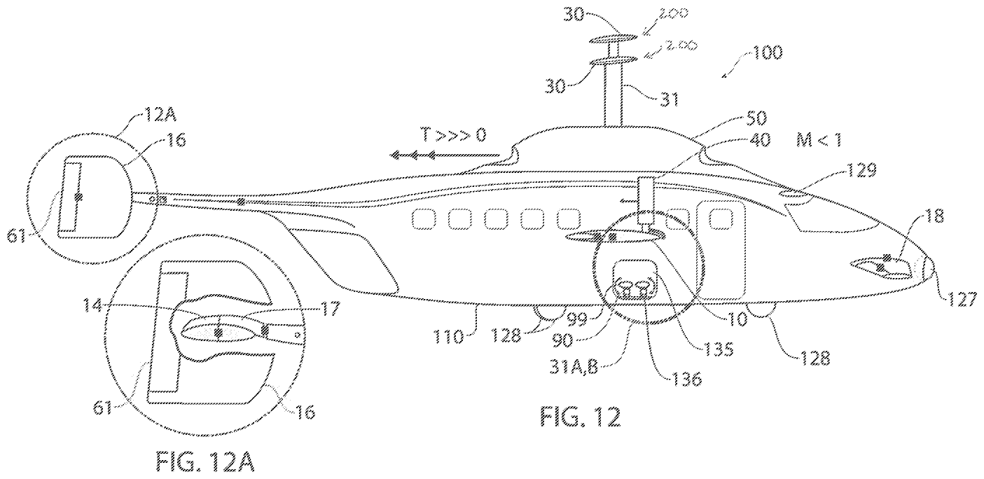

FIG. 12 shows the aircraft in a medium speed configuration with the main wing in non-adjusted condition of angle of incidence. The Engine is now producing more forward thrust. The ducted fans 40 are also producing forward thrust. Both RLD 200 have been parked in a perpendicular to the fuselage orientation as auxiliary wings and adjusted to provide angle of incidence, to increase their lifting capacity. The canard is now in the non-adjusted mode. FIG. 12A depicts that the empennage 109 is now operating as a non-adjusted flight control system.

These combinations of capabilities are additional factors in permitting the RLD to be converted to parked auxiliary wings at slow speed.

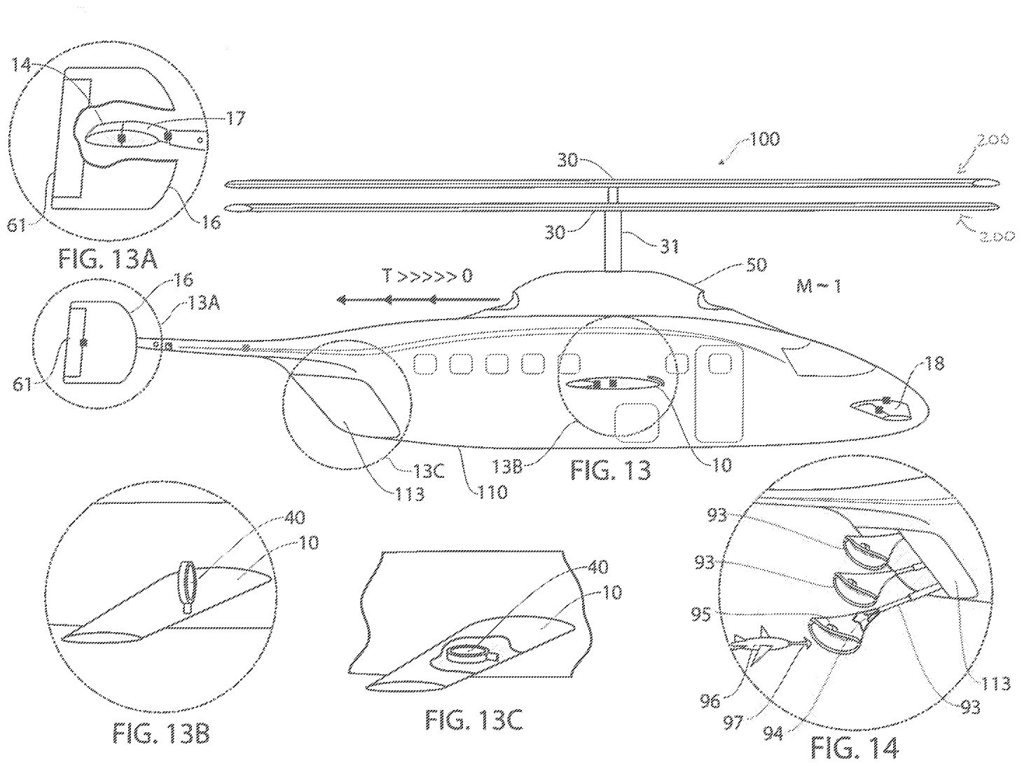

FIG. 13 illustrates the aircraft in high-speed flight with the engine producing high power. The canard, the wing, and the empennage as depicted in FIG. 13A, all are in non-adjusted angle of incidence positions. The rotational lifting devices are now parked as auxiliary wings, in oblique orientation to reduce drag at high speed.

FIG. 13B depicts the wing in a swept position to reduce Drag at high-speed.

FIG. 13C shows the ducted fan retracted into the wing to reduce drag at high-speed

FIG. 14 depicts the unmanned aerial vehicle (UAV) launch and retrieval system whereby UAVs can be stored within the fuselage and launched either in groups or singularly and then retrieved to download their stored data, and be serviced, replenished, refuelled, and reprogrammed for relaunch. The system includes a retractable launch/ capture dock 93 an orientation transmitter 95 to guide the UAV 96 with its data transfer-latch probe 97 to the appropriate docking port, with its combined data latching mechanism/upload-download port 94.

Referring to FIG. 15A, the rotational lifting device (RLD) according to a first embodiment of the invention is shown generally at 200. At least one RLD 200 may be rotatably installed on an aircraft (not shown) to enable vertical take-off and landing, as is commonly known. As outlined above, the RLD 200 is comprised of a pair of elongate RLD segments 30 with a plurality of air nozzles extending therethrough to enhance airflow therearound, as will be set out below. The airflow through the air nozzles may be supplied and controlled by a plurality of control systems, as will be set out below.

The RLD 200 extends along a central axis 500 between distal ends 202 with a midpoint 204 therebetween. The RLD 200 includes upper and lower surfaces, 206 and 208, respectively, as illustrated in FIG. 20, and first and second edges, 222 and 224. The RLD 200 is a rigid/semi-rigid full span tapered airfoil, rotatable about the midpoint 204 by any commonly known means such as mechanical, pneumatic, electric or any other known means. The RLD 200 is fluidically connected to an air supply through an RLD airfoil plenum 35 extending through the RLD segments 30 proximate to the midpoint 204, as will be set out below.

The interior of the RLD 200 is represented schematically in FIG. 15A. The RLD 200 includes a compressed air supply RLD control system 210, supplied with compressed air through the plenum 35. A rotatable bidirectional thrust nozzle 23 is located at each of the distal ends 202 of the RLD segments 30, the purpose of which will be set out below. The control system 210 includes a plurality of compressed air supply lines 47 fluidically connected between the plenum 35 and the thrust nozzles 23 with a plurality of control valves 21 and modulating valves 22 therebetween. The compressed air may be selectively delivered though the control valves 21 and modulating valves 22 to the thrust nozzles 23, as is commonly known.

Referring now to FIG. 15B, the control system 210 may also include a plurality of tip vortex-inhibiting vane nozzles 26 proximate to the distal ends 202. The vane nozzles 26 are fluidically connected to plenum 35 through the supply lines 47 with a plurality of modulating valves 22 and control valves 21 therebetween. The vane nozzles 26 will be outlined in further detail below. Although the current embodiment is illustrated with air supplied from the plenum 35, it will be appreciated that air to supply the nozzles 23 and 26 could be collected passively from air collection ports or slots in the RLD segments 30 during rotation of the RLD 200 or when used as a wing.

Turning now to FIG. 150, the thrust nozzle 23 at a distal end 202 is illustrated in further detail. The thrust nozzle 23 is used to power and modulate the rotation of the RLD 200. The thrust nozzle 23 is formed in a T-shape, with an air supply portion 212 and an air expulsion portion 214. The air expulsion portion 214 extends between distal ends 216 with openings at both distal ends 216 fluidically connected through the supply portion 212 to the control system 210. The thrust nozzle 23 is rotatable about the supply portion 212, in a direction as indicated at 220. The T-shape allows for air to be alternatingly discharged from either end in rapid succession whereas the rotational ability of the thrust nozzle 23 permits air to be discharged in both a horizontal and an angular orientation about the length of the RLD segment so as to provide rotational force to the RLD as well as lift or downforce thereto. It will be appreciated that such lift or downforce may be desirable to reduce the effects of vibration on the RLD segments or to prevent stacked RLDs from impacting each other. This provides for rapid intervention to modulate the rotational speed of the RLD 200, as well as to control the RLD 200 during a “park” sequence. The rotatable capability enables control of the separation between a plurality of stacked RLDs 200. The shape of the air expressed from either of the thrust nozzles 23 is independently and fully adjustable from focus to wide dispersion, variable from a round to a flat pattern. This embodiment provides the option of influencing airflow at the distal ends 202 and augments the vane nozzles 26. It also provides the capability to alter the nozzle effect to respond to rotor speed change requirements and function changes of the RLD 200.

Turning now to FIG. 16, the RLD 200 may include an adjustable RLD weight system 230. The weight system 230 includes a plurality of compressed air supply lines 47 fluidically connected between the plenum 35 a longitudinal cylindrical passage 232 with plurality of modulating valves 22 and control valves 21 therebetween. The compressed air may be selectively delivered though the control valves 21 to the modulating valves 22, as is commonly known. The cylindrical passage 232 extends between inboard and outboard ends, 234 and 236, respectively. An adjustable RLD weight 38 is slideably contained within the cylindrical passage 232. As illustrated, a first modulating valve 22a is located proximate to the outboard end 236 of the cylindrical passage 232 and a second modulating valve 22b is located proximate to the inboard end 234. The weight 38 may be selectively located at any location within the cylindrical passage 232 by controlling the airflow therein using the modulating valves 22a and 22b. During initial rotational movement of the lifting device and during the RLD 200 “park” sequence it is preferable to have the weight 38 inboard proximate to the inboard end 234 so that less torque is required, allowing greater precision. Once full velocity rotation is achieved, it is preferable to have the weight 38 in the outboard position proximate to the outboard end 236 to result in greater strength, balance, and stability of the RLD 200, provided by additional centripetal force. The extra centripetal force is also beneficial in the event of a loss of trust, as it improves the rotation of the freewheeling RLD 200 during unpowered descent, which acts as an autogryo to enable a controlled descent. As illustrated herein the weight 38 is configured as a piston slidably located within the cylindrical passage 232. It will be appreciated that in such configuration the piston does not exert any force on any other object but rather is merely moved longitudinally within the cylindrical passage 232 as described above.

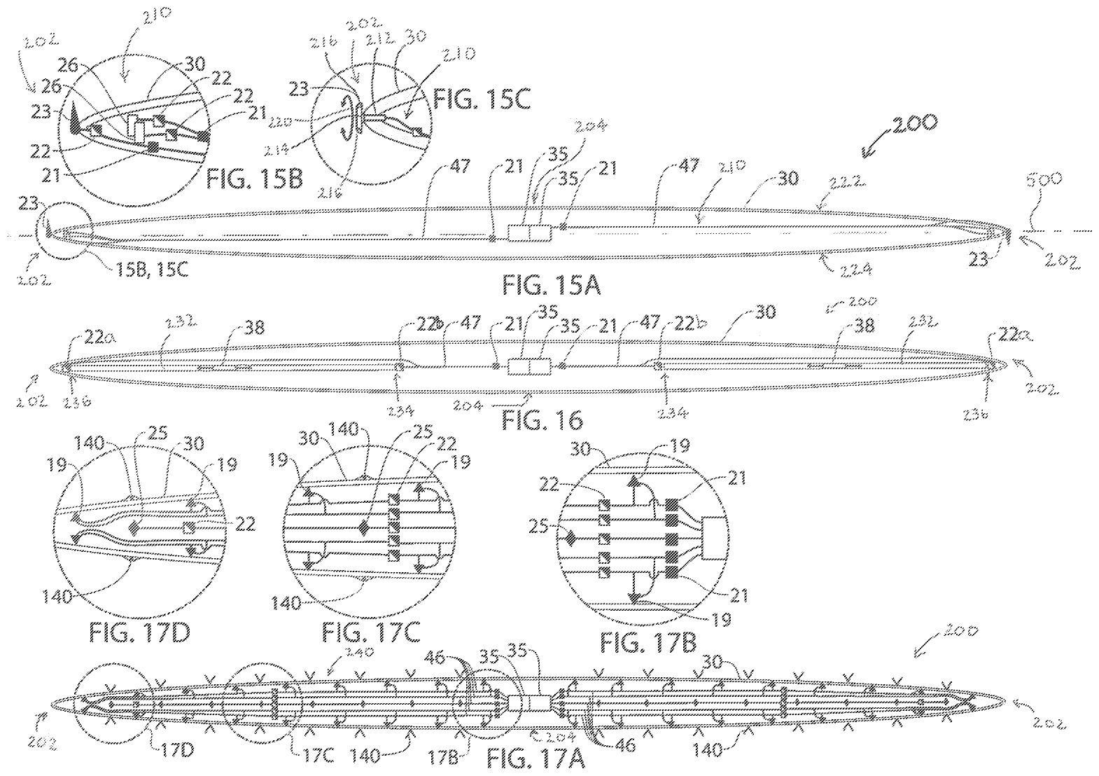

Referring now to FIGS. 17A through 17D, the RLD 200 may include a plurality of passive air supply and exhaust ports 140 distributed throughout the RLD segments 30, the purpose of which will be further set out below. The RLD 200 may include a compressed air RLD airflow enhancement system 240. The airflow enhancement system 240 includes a plurality of combination sheet/stream nozzles 19 and bi-directional laminar flow enhancement nozzles 25 distributed throughout the RLD segments 30. The combination sheet/stream nozzles 19 and bi-directional laminar flow enhancement nozzles 25 are fluidically connected to the plenum 35 through a plurality of enhancement system air supply lines 46 with a plurality of control valves 21 and modulating valves 22 therebetween. The combination sheet/stream nozzles 19 and bi-directional laminar flow enhancement nozzles 25 improve the lifting capability and efficiency of the RLD 200 and allow for the interchangeability of the leading and trailing edges of the wing, as further described below. The air can be modulated through the various nozzles, 19 and 25, creating varying effectiveness throughout the span. Either edge can be designated leading or trailing, to facilitate parking the RLD 200 by creating a fixed wing circulation without requiring further adjustment. Additionally, the ability to modulate the effectiveness of the nozzles, 19 and 25, also provides the ability to alter the lift disk effect, similar to cyclic and collective action on a typical helicopter; without the complex and heavy pitch changing devices found on a typical helicopter.

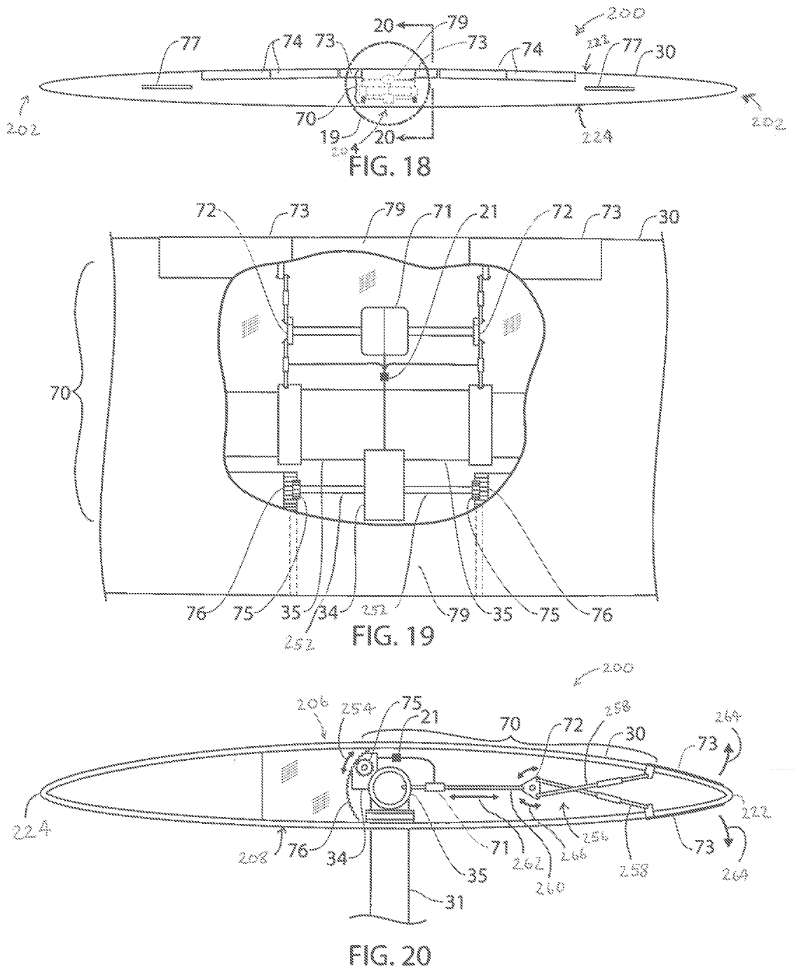

Referring now to FIGS. 18 through 20, the RLD 200 includes a pitch and angle of incidence (AOI) adjustment control system 70. In particular, FIG. 19 illustrates a section of the RLD with a cutaway through the shroud 79 as will be described below connecting two RLD segments 30 so as to improve airflow therepast. The pitch and AOI adjustment control system 70 includes a pneumatically controlled AOI adjustment drive 34, as illustrated in FIGS. 19 and 20, located within the RLD segments 30 proximate to the midpoint 204. The AOI adjustment drive 34 is fluidically connected to the plenum 35 with a control valve 21 therebetween. The AOI adjustment drive 34 includes a driveshaft 252 extending laterally therefrom with a pair of pitch and angle of incidence (AOI) adjustment gears 75 at the distal ends thereof extending towards the distal ends 202. The pitch and AOI adjustment gears 75 are rotated by the AOI adjustment drive 34 and engage upon a pair of individual segment adjustment rack gears 76. The concave rack gears 76 extend between the upper and lower surfaces, 206 and 208, and are operable to pivot the RLD 200 about a horizontal axis in a direction indicated at 254 in FIG. 20 to set the angle of incidence between the first and second edges, 222 and 224. In operation, the pitch and AOI adjustment system gears 76 may be operable to rotate the RLD segments in the same or opposite directions and by the same or different degrees to permit lifting as a rotor or as a fixed wing.

The pitch and AOI adjustment control system 70 further includes a mechanical stability control device 256. The stability control device 256 includes a pair of adjustment vanes 73 located proximate to the midpoint 204, on either side thereof, on the upper and lower surfaces, 206 and 208, respectively, of the first edge 222. The adjustment vanes 73 are pivotable in a direction indicated at 264 and are mechanically controlled with actuating rods 258 extending between an actuator 72 and the adjustment vanes 73. A control actuating rod 260 with a position lock actuator 71 thereon extends between the plenum 35 and the actuator 72 and may be laterally adjusted in a direction indicated at 262 to rotate the actuator 72 in a direction indicated at 266. When the desired angle of incidence is achieved, the position lock actuator 71 is engaged. When the RLD 200 is in rotation, greater force is required to affect adjustment, and the adjustment vanes 73 are controlled by the actuator 72 to assist the change required by employing aerodynamic force.

As illustrated in FIG. 18, stability control vanes 74 are also included on the first edge 222 of the RLD 200. The stability control vanes 74 are controlled in the same fashion as the adjustment vanes 73. The stability control vanes 74 are used in conjunction with combination sheet/stream nozzles 19 and bi-directional laminar flow enhancement nozzles 25 to stabilize the wing when it is in oblique orientation at very high speed.

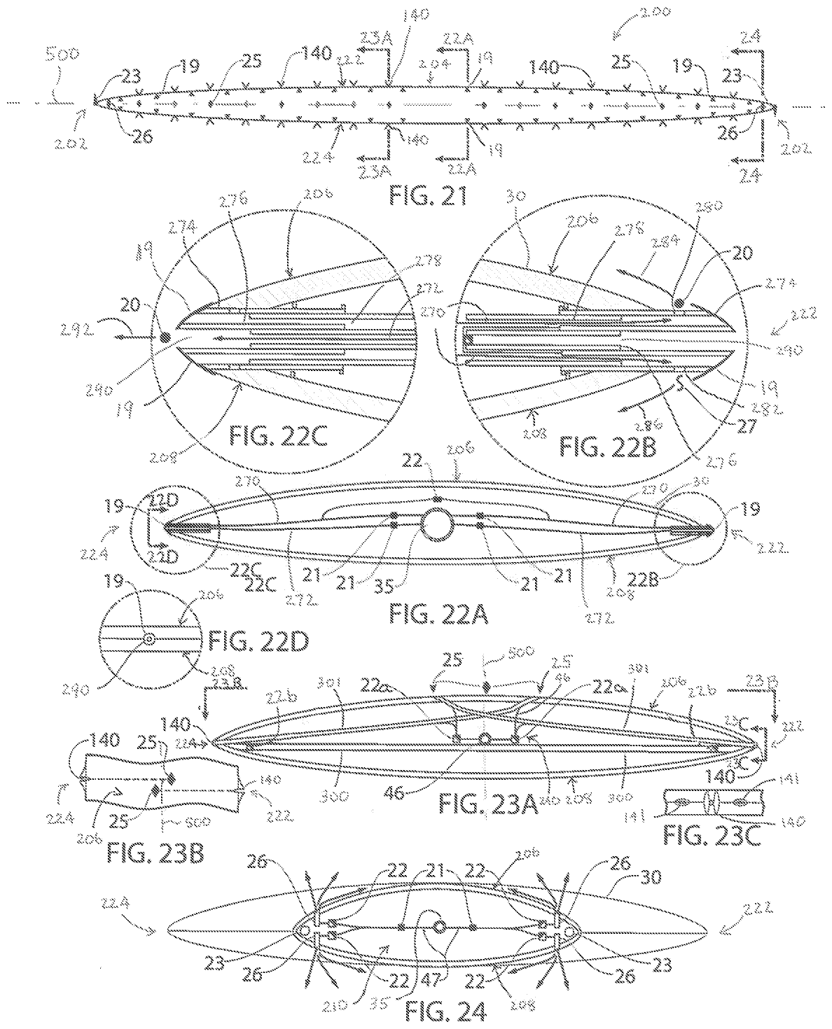

Turning now to FIGS. 21 and 22A, a pair of combination sheet/stream nozzles 19 are illustrated at one location along the RLD segments 30 proximal to each of the first and second edges, 222 and 224, respectively. The combination sheet/stream nozzles 19 are fluidically connected to the plenum 35 with control valves 21 therebetween and are controlled by manipulating the control valves 21, as is commonly known. Each combination sheet/stream nozzles 19 is fluidically connected to the plenum 35 with an outer nozzle supply line 270 and an inner nozzle supply line 272, the purpose of which will be set out below.

Referring to FIG. 22B, each combination sheet/stream nozzle 19 includes an extendable outer nozzle portion 274 and a stationary inner nozzle portion 276. An annular outer flow passage 278 extends through the combination sheet/stream nozzle 19 between the extendable outer nozzle portion 274 and the stationary inner nozzle portion 276, with an upper and lower bore, 280 and 282, respectively, therethrough. A central inner flow passage 290 extends through the stationary inner nozzle portion 276 and out the center of the extendable outer nozzle portion 274. When air is supplied to the combination sheet/stream nozzle 19 through the outer nozzle supply line 270, the air enters the outer flow passage 278 and forces the extendable outer nozzle portion 274 away from the RLD segments 30, as is commonly known. In this extended position, air in a sheet shaped airflow from the sheet nozzles 20 is expelled from the upper bore 280 over the upper surface 206 in a direction indicated at 284 while air in a stream shaped airflow from the stream nozzles 27 is expelled from the lower bore 282 over the lower surface 208 in a direction indicated at 286. The sheet shaped airflow from the sheet nozzles 20 over the upper surface 206 increases the laminar flow and helps to keep the flow in a direction that is perpendicular to the span. The increased laminar flow increases lift, while the flow direction control helps to reduce span-wise airflow, which would cause increased tip vortex. The lower stream shaped airflow from the stream nozzles 27 over the lower surface 208 helps maintain airflow perpendicular to the span, reducing wingtip vortex, and increases underwing pressure. By selecting the outer nozzle supply line 270 causing the nozzle to extend, it orientates the selected first or second edge, 222 or 224, to be effective as a leading edge of a wing. The extendable outer nozzle portions 276 may be rotatable either through pneumatic or other means to adjust the orientation of the nozzle therethrough to be substantially perpendicular to the entering airflow thereby increasing the intersection of airflow at higher pitch altitudes. In the case of the trailing edge, this rotation provides the ability to create the effect of either a more deeply cambered wing or a reflex wing.

Turning now to FIG. 22C, when air is supplied to the combination sheet/stream nozzle 19 through the inner nozzle supply line 272, the airflow is directed through the central inner flow passage 290, and the extendable outer nozzle portion 274 remains in a retracted position. In this configuration, a sheet shaped airflow from the sheet nozzles 20 is expelled from the combination sheet/stream nozzle 19 in a direction indicated at 292, which effectively increases the cord of the wing, improves the Kutta Effect, induces and entrains airflow on both the upper and lower surfaces, 206 and 208, respectively, and promotes boundary layer adhesion. By selecting the inner nozzle supply line 272, the selected first or second edge, 222 or 224, is oriented as a trailing edge. FIG. 22D depicts one of the possible raised profiles with the circular opening of the central inner flow passage 290 of the combination sheet/stream nozzle 19, on an edge, 222 or 224, of an RLD 200 although it will be appreciated that other profiles may be useful as well.

During higher speed flights, air may be permitted to bypass through the RLD segments by opening the modulating valve 22b on the bridging channel 300. This allows the air to enter a port at proximal to the leading edge and exit a nozzle proximal to the trailing edge, creating a passive air supply exhaust channel. This helps to relieve leading edge pressure and increases trailing edge effectiveness, and it also increases entrainment/inducement, while reducing turbulent airflow. Furthermore, during low speed flight where the RLD Segments are oriented to a high angle of inclination, the valves 22a corresponding to the trailing edge may be opened so as to pressurize the trailing edge air supply and exhaust ports 140 as well as the trailing edge top side bidirectional laminar flow enhancement nozzles 25 so as to discharge air therethrough. As illustrated each valve 22a is operably connected to the air supply and exhaust ports 140 and nozzles 25 such that the valve 22a corresponding to the trailing edge may be opened in that configuration. The air supply and exhaust ports 140 and nozzles assist in entraining air passing over the RLD segments so as to increase efficiency of the aircraft.

Turning now to FIGS. 23A through 23C, the bi-directional laminar flow enhancement nozzles 25 and the passive and pressurized air supply and exhaust ports 140 are illustrated in further detail. Note that for clarity in FIGS. 17A-D and 21, the bi-directional laminar flow enhancement nozzles 25 are represented as single diamond symbols on the upper surface 206 along the central axis 500, but as illustrated in FIG. 23A, each single diamond symbol includes a pair of bi-directional laminar flow enhancement nozzles 25 situated on either side of the central axis 500 of the upper surface 206. Each bi-directional laminar flow enhancement nozzle 25 and passive air supply and exhaust port 140 is fluidically connected to the compressed air RLD airflow enhancement system 240 through enhancement system air supply lines 46, with a plurality of modulating valves 22 therein to select the direction of compressed airflow therethrough. Additionally, each bi-directional laminar flow enhancement nozzle 25 is fluidically connected to a passive air supply and exhaust port 140 on the opposite side of the central axis 500 with a bridging channel 300 therebetween. This configuration allows for the system of operation to be available regardless of the direction of rotation of the RLD 200. By opening the appropriate modulating valve 22, compressed air can be directed towards the bi-directional laminar flow enhancement nozzles 25 on the selected trailing edge of the RLD 200. Additionally, air may be supplied to the bi-directional laminar flow enhancement nozzles 25 proximal to the trailing edge side by passively collecting air from the passive air supply and exhaust ports 140 located on the leading edge side of the RLD 200, or during flight when the RLD 200 is operated as a wing. The compressed air, or passively collected air, or a combination thereof, exits the bi-directional laminar flow enhancement nozzles 25 on the designated trailing edge side. Situated near the location where boundary layer separation typically occurs, the airflow from the bi-directional laminar flow enhancement nozzle 25 helps to entrain adjoining air to follow the upper surface 206 of the RLD 200 and helps to increase boundary layer adhesion proximal thereto. Situated proximal to the trailing edge of the RLD 200, the passive air supply and exhaust ports 140 express the air to enhance the integration of the upper and lower surface airflows; and help to relieve leading edge pressure as well as entrain additional airflow. These influences result in decreased drag and less turbulent air; through which the following rotational lifting device will pass.

As outlined above and further illustrated in FIG. 23B, the bi-directional laminar flow enhancement nozzles 25 are located on either side of the central axis 500. The bi-directional laminar flow enhancement nozzles 25 may be offset from each other along the upper surface 206 between the first and second edges, 222 and 224, and are fluidically connected with the passive air supply and exhaust port 140 located at the edge on the opposite side of the central axis 500. As illustrated in FIG. 23C, the exhaust ports may be have raised structures therearound or may also include oval shaped ports through the RLD segment. In operation, air through the bypass passage may be directed from the raised air supply and exhaust ports 140 and to the oval exhaust ports 141. The bi-directional laminar flow enhancement nozzles 25 may be located at any position on the RLD segments 30 between the leading or trailing edge and the axis 500 depending upon intended design of the RLD segments taking into consideration, for example, the intended speed, angle of attack and dimensions of the RLD segments. FIGS. 23B and 23C further illustrate one embodiment of the shape of the passive air supply and exhaust ports 140. During RLD rotation or forward flight the shape of the passive air supply and exhaust ports 140 results in the air being forced into the centre circular opening as well as elliptical contoured orifices on either side. It is also deflected up and down across the upper and lower surfaces of the airfoil, as it is trapped to a degree by the shape of the nozzle. The airstream that is forced up and over, as well as down and under the airfoil, induces the general airflow to be perpendicular to the length of the airfoil and create small shear zones that result in vortices which improve the boundary layer attachment. Additionally, air is forced into the forward upper surface contoured bi-directional laminar flow enhancement nozzle 25 which helps to entrain airflow and reduce boundary layer separation. This augmentation is a benefit to enhance airfoil efficiency and capability during initial or slower rotation of the airfoil, or when large pitch angles are required to create greater lift. In that instance, the improved pressurized and passive airflow allows for greater pitch angles with less concern for lift degradation or stall.

For clarity of illustrative purposes, the Bi directional laminar flow and enhancement nozzles 25 are shown near the apex of the representative camber and the passive air supply and exhaust ports 140 are shown at the apex of the trailing and leading edges. There are various locations where a plurality of the ports/nozzles could be located to enhance airflow entrainment and boundary layer adhesion. The ports have been shown as circular but could be oval, elliptical, or elongated oval, or slot shaped.

Turning now to FIG. 24, the tip vortex inhibit vane nozzles 26 are illustrated in further schematic detail. As set out above, air is supplied to the vane nozzles 26 through the control system 210, through a plurality of control valves 21 and modulating valves 22. The vane nozzles 26 are located proximate to the distal ends 202, or the tips, of the RLD segments 30, extending through both the upper and lower surfaces, 206 and 208, respectively, as illustrated in FIGS. 15B and 24.

Alternatively, or additionally, the vane nozzles 26 may be located at a more inboard location on the airfoil, in streams directed upwards and or/downwards from the airfoil. The streams combine to create a vane effect, this shape of which is continuously optionally variable from an “open palm and finger” shape through a “picket fence” shape to a “wall shape”. The shape can be biased to be more or less dense in any particular area throughout the 180° range of the upper and lower nozzles. Additionally, the projected direction of the individual streams is continuously optionally variable from an inboard direction through to an outboard direction. The velocity and density of the airstreams is also continuously optionally variable.

These variable modifications to the vane effect can be cyclically programmed to react to or counteract the changing conditions and forces encountered during the rotation of an airfoil and through the full range of velocity of an aircraft. By doing so, the vortex that is typically created at a wing or rotor tip is inhibited, and therefore drag and turbulence is reduced in the air that the following RLD would encounter. The pressurized air expressed can also amplify the thrust at the tip of the RLD; additionally it can assist the thrust angle with the upward and downward vectoring of the tip. As the vanes are created by air, not a solid structure, they bend with the changing pressure, making it possible to create this inhibiting effect on air flowing span-wise and chord-wise on opposite rotating surfaces. Although bending air pressure on a fixed wing tip vortex inhibiting vane is not a factor, it is nevertheless an improvement to use a tip nozzle vortex inhibit device, as it greatly reduces the complexity and weight compared to a fixed winglet structure.

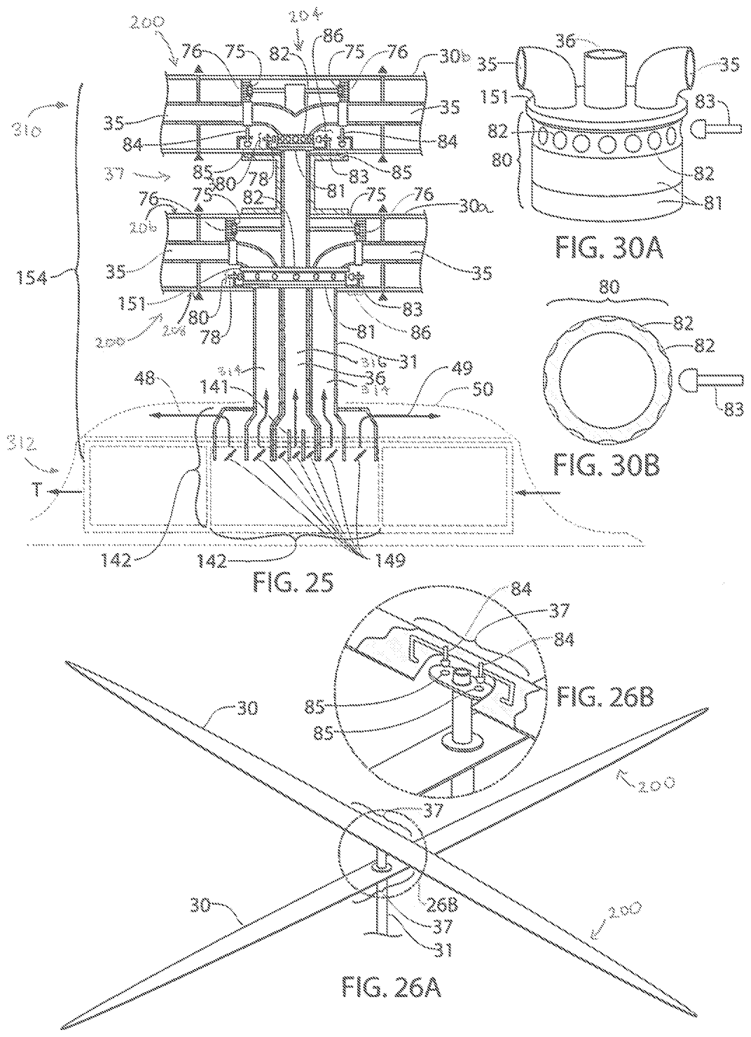

Turning now to FIG. 25, an RLD assembly hub is shown generally at 154. The hub 154 extends between a bottom and a top, 310 and 312, respectively and provides a plurality of passages for compressed air to be supplied to the plenums 35 within each RLD 200, as will be further set out below. The bottom 310 of the hub 154 includes a main plenum metering assembly 142 extending into the engine 50. An RLD system hub outer plenum/lower RLD support assembly 31 extends from the main plenum metering assembly 142 towards the top 312 and is rotatably mounted to a first RLD body 30a through the lower surface 208 at the midpoint 204 with a rotational drive mechanism 80, as will be further set out below. An RLD system hub mid-plenum/upper RLD support assembly 36 extends through the RLD system hub outer plenum/lower RLD support assembly 31 and through the first RLD body 30a and through a fixed offset coupling mechanism 37 between the first RLD body 30a and a second RLD body 30b and is rotatably mounted to the second RLD body 30b with a rotational drive mechanism 380. The fixed offset coupling mechanism 37 and rotational drive mechanism 380 will be outlined in more detail below.

Compared to a typical helicopter masthead, which has many intricate moving parts, this configuration is simple and lightweight. Although the present embodiment is shown as an air-driven system, it could also be driven by such as, by way of non-limiting example, electrical, hydraulic, electro-magnetic, or mechanical systems. It should also be known that although this embodiment depicts a concentric RLD hub plenum support assembly for double RLDs, it could also be constructed as a single lifting device or more than two lifting devices, by simply adding or subtracting the individual elements, one on top of the other. In operation, the entire RLD assembly hub 154 as well as the RLDs 200 are rotated in a desired direction such that a vertical vector of the thrust produced is therefore able to provide a vertical (either forward, backwards or to either side of the aircraft) movement.

The main plenum metering assembly 142 includes a plurality of passages to deliver compressed air to a plurality of systems, with a plurality of main plenum metering valves 149 therein to control the amount of air delivered to each system, as is commonly known. An outer annular passage 314 extends through the RLD system hub outer plenum/lower RLD support assembly 31 from the main plenum metering assembly 142 to the first RLD body 30a and supplies compressed air to the plenum 35 therein, as will be outlined below. An inner passage 316 extends through the RLD system hub mid-plenum/upper RLD support assembly 36 and provides an air supply for an additional RLD 141 to the plenum 35 in the second RLD body 30b, as will be set out below. Air passages provide a fuselage, canard, empennage, and main wing airflow enhancement compressed air supply 48 and a fuselage, canard, & main wing function control compressed air supply 49, respectively.

The air is drawn from the compressor section of the APU and turbine engine 50 into the Main plenum metering assembly 142 through the main plenum metering valves 149. From there it is distributed to the outer annular passage 314 in the RLD system outer plenum/lower RLD support assembly 31 and the inner passage 316 in the RLD system mid plenum/upper RLD support assembly 36. The air is then distributed to the airfoil plenums 35 in each RLD 200. The RLDs 200 rotate upon the rotational drive mechanisms 80 or 380 with rotational bearings 81 by motive force provided from the rotatable thrust nozzles 23 (not shown in FIG. 25).

Each individual RLD is lockable at any angle between parallel and perpendicular to the fuselage 110 {not shown} by engaging the male portion 83 of the sweep angle locking mechanism 86 into the female portion 82 of the sweep angle locking mechanism 86 as shown on FIGS. 25, 30A, and 30B. This individual locking mechanism provides the capability to park the rotational lifting device in any position between parallel and perpendicular to the fuselage, to perform as an auxiliary wing, then change the angle of incidence of the wing using the Angle of incidence adjustment drive gear 75 and the Angle of incidence adjustment wing rack gear 76 (as more particularly seen on FIGS. 19 and 20) to create a more efficient higher lift wing. The sweep angle locking mechanism 82 & 83 is also used to arrange the RLD in oblique orientations for high speed cruise. Each rotational drive mechanism 80 is paired with a RLD brake 78. The RLD fixed offset locking plunger 84 and the RLD fixed offset locking receptacle 85 are depicted here and on FIG. 26A a further embodiment will provide a gimbled plenum and support to provide disk angle adjustment. To further enhance the performance of this embodiment it is preferable to use a turbine-fan engine that is capable of temporarily disconnecting the fan drive, when using the compressed air as motive force.

FIG. 26A depicts The multi-rotor fixed offset coupling mechanism 37 whereby the rotational lifting devices are configured in a 90° offset for two levels of RLD, or 60° (not shown), for three levels of RLD and the fixed offset locking plunger 84 is inserted into the fixed offset locking receptacle 85 creating an efficient Multi-rotor system, as further depicted in FIG. 26B

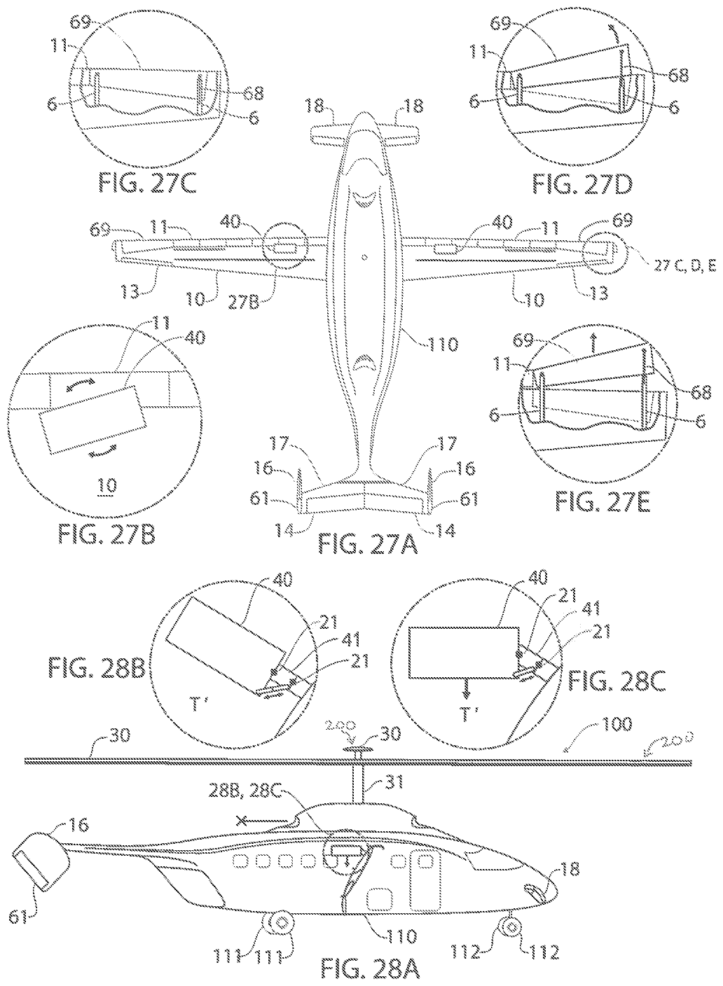

FIG. 27A depicts the ducted fans 40 located on the top surfaces of the transformable main wing 10. Also shown is a leading edge slat 69, with a shape modified from the other leading edge slats 11.

FIG. 27B shows the fans are rotatable across the span of the wing.

FIG. 27C shows an expanded representation of the right outer wing area of FIG. 27A depicting a cutaway view of the adjustable leading edge sweep slat 69, and showing the leading-edge slat guide rails 6. Also shown is the telescopic extendable slat guide rail 68 on the outer edge of the slat.

FIG. 27D shows the telescopic extending slat guide rail 68 extending the outer portion of the slat, which provides forward sweep of the outer portion of the wing. An effect of the forward sweep is a reduced tendency to create drag inducing tip vortex. An additional effect of the sweep is an enhancement and redistribution of the lifting capability of the wing, which reduces potential for tip stall.

FIG. 27E shows the modified shaped slat still operates automatically on the leading-edge slat guide rails 6 in concert with the other slats; irrespective of whether it is extended in sweep mode FIG. 27D or retracted as in FIG. 27C.

The embodiments in this system support the lifting capability and low-speed stability which enable the transformation to and from fixed wing flight.

FIG. 28A shows the orientation of the ducted fan, attitude control assist, vectored thrust, laminar flow enhancement device 40 on the aircraft in its most extended position, as also seen in FIG. 28C

FIGS. 28B shows that the fan is mounted on a mast 41 on an axis perpendicular to the transformable main wing and rotates with the change of incidence of the wing. Further, as shown in FIG. 28C, using control valve 21 the ducted fan can be further rotated to be placed in a horizontal position to provide vertical thrust assistance and attitude control assistance in the hover mode, as depicted in FIG. 28A. The positioning of the fan on top of the wing provides laminar flow improvement while also providing vectored thrust. This embodiment depicts a ducted fan but a retractable open rotor could be used in another embodiment

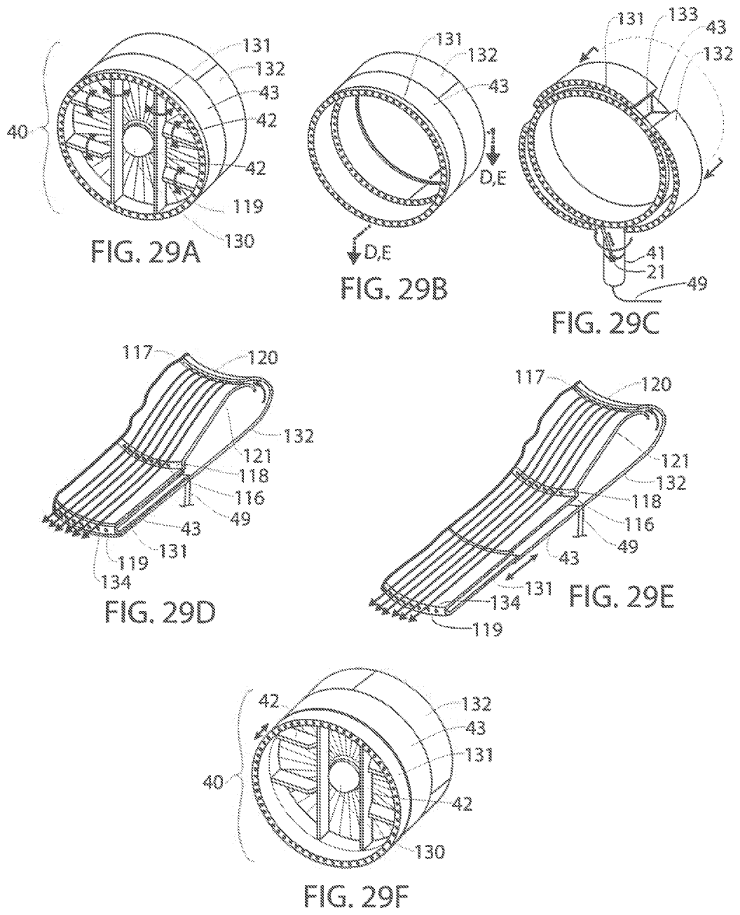

FIG. 29A depicts the Ducted fan, attitude control assist, vectored thrust, laminar flow enhancement device 40, with the ducted fan forward segmented retractable shroud 132 in the extended position, and showing the ducted fan vector vanes 42 which can be used to direct the air up or down, left or right, or even in opposite directions by positioning the vanes in opposing angles. This feature, in conjunction with the rotatable mast 41 shown on FIG. 290 provides for improvement of the laminar flow enhancement pattern, improving the vectored thrust, and assisting in changing the angle of incidence of the wing. The manipulation of the vanes also permit rapid attitude adjustment control. Also shown on this figure are the Electric Back-Up drive 130 for the ducted fan 40, the ducted fan shroud 43, the ducted fan aft shroud step 119, on the ducted fan aft shroud 131, in a partially extended orientation.

FIG. 29B is a representation of the fan shrouds in order to reference locate elements depicted in FIGS. 29D and 29E.

FIG. 290 is a representation of the fan shrouds (43, 131 & 132 in a fully retracted position. Also shown are the segmented shroud extend/retract device 133 and the ducted fan mast 41 with its control valve 21 which provides for the rotation and angle adjustment as shown by arrows. Additionally, the fuselage, canard, empennage, and main wing function control compressed air supply lines 49 is shown. In this mode the ducted fan 40 can be retracted into the wing, as shown in FIG. 130. This embodiment allows the latent drag of an exposed fan to be eliminated at high-speed

FIG. 29D depicts a section of the ducted fan shrouds as reference located on FIG. 29B. This section indicates the forward shroud 132 extended and the aft shroud 131 retracted. The leading edge 120 of shroud 132 is shaped to create an airfoil flowing back over the curvature 121 of the inner side of the shroud which is receding. Compressed air is forced out of the leading edge slot 117 and follows the receding inner side, which induces and entrains air to follow the higher velocity air flow through the fan. Additional air is also entrained to follow around the outside of the shroud.

To further enhance the capability of the ducted fan, air is forced out of the first step at 118 through nozzles 116, and flows along the inner edge of the shroud 43 in this area where the blade tips would be rotating. The air directed in these manners improves the density of the exhaust of the fan and creates an effective air bearing between the fan blade tips and the inner side of the shroud. This permits greater tolerance of the gap between the fan tips and the shroud, and creates greater thrust density.

Further compressed air is forced out through the ducted fan trailing edge nozzle array 134 at the ducted fan aft shroud step 119 of the retracted shroud 131. This feature extends the effect of the exhaust fan duct and entrains more air from outside of the shroud.

FIG. 29E shows a section of the shrouds as reference located in FIG. 29B. In this view, the ducted fan shrouds are fully extended to provide the maximum thrust focus and density.

FIG. 29F depicts the ducted fan 40 in an almost fully extended mode.

The aft portion of the ducted fan shroud has been extended to provide greater focus effect for the control vanes behind the fan. Additionally (FIG. 29E) shows a particular shape for the shroud. This is an inventive step, in that the airflow is greatly increased by being forced over the particularity designed shape of the leading edge 120, outlet slot 117, inner shroud contour 121, and steps 118 & 119. This both induces and entrains additional air movement in and around the ducted fan. The stepped shape in the back portion of the shroud is the area where the tips or ends of the fan blades rotate and the increased volume, pressure, and velocity airflow exits the shroud to be vectored by the vanes 42 & 43. This shroud shape and air provided from compressed air supply lines 49 creates greater and more effective thrust, while the steps reduce the necessity for exact narrow tolerance at the blade tips. These embodiments improve the effectiveness of the ducted fans in all modes and capabilities, thereby enabling the transformable nature of the aircraft.

FIGS. 30A&B are shown on page 16/26 of the figure section and described above.

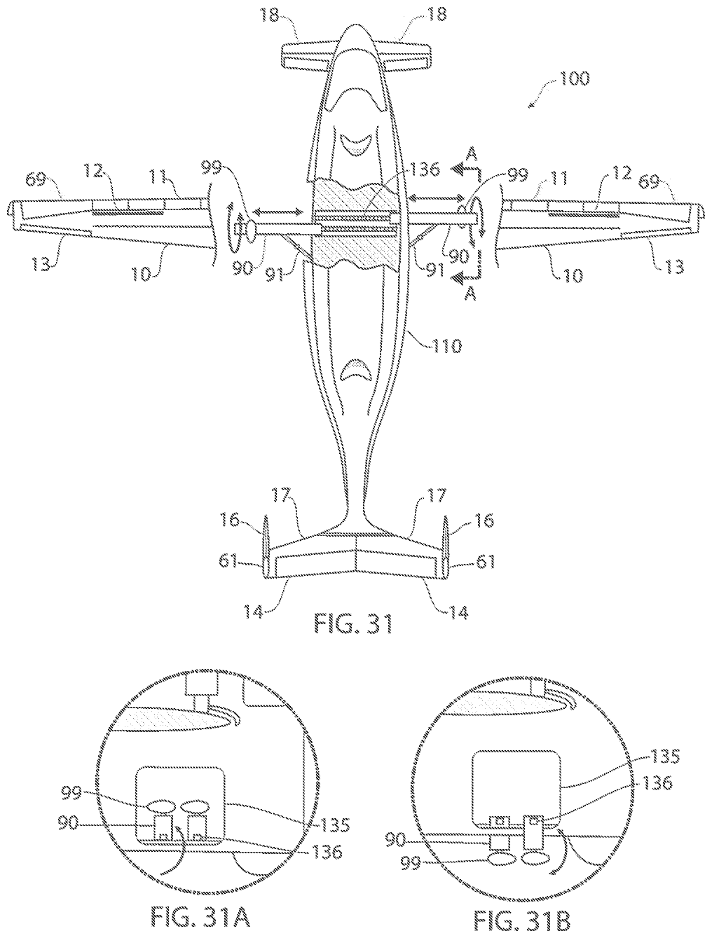

FIG. 31 depicts the retractable, rotatable, ordinance sensor rails 90 {A portion of the wings has been removed from the figure for clarity in presentation of this device} in order to permit high-speed cruise, the parasite and induced drag needs to be limited. By carrying bulky items on the interior of the fuselage the drag profile is improved. When required, the rails can be extended to either side of the fuselage, then rotated 180 degrees, so that whatever is mounted on the rail is now below the bottom line of the fuselage 110 and below the level of the canard 18. By manipulating the rails the site line of any sensor and the firing line of any ordinance is below the level of the bottom of the fuselage, and therefore unimpeded. The retractable hinged stabilizing brace 91 helps absorb the force of any ordinance firing. Additionally it stabilizes the rail to reduce vibration of any sensor mounted. Another feature of this mechanism is the ability to change sensors or reload ordinance while airborne.

FIG. 31A depicts the fuselage ordinance/sensor rail port 135 open, with ordinance/sensor devices 99 mounted on the retractable, rotatable ordinance sensor rails 90 in the upright and retracted position on the fuselage ordinance sensor rail rack 136.

FIG. 31B depicts the ordinance/sensor devices in the extended position and rotated below the fuselage level.

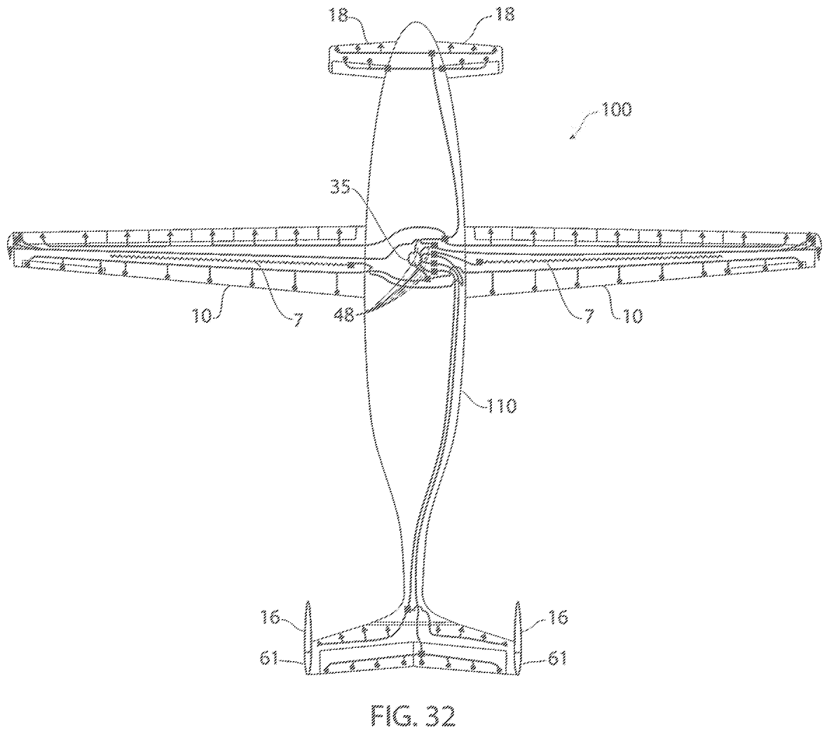

FIG. 32 depicts the airflow enhancement devices compressed air supply distribution, which is supplied from the engines and/or the APU, Via the fuselage, canard, empennage, and main wing airflow enhancement compressed air supply lines 48 to the various devices as shown.

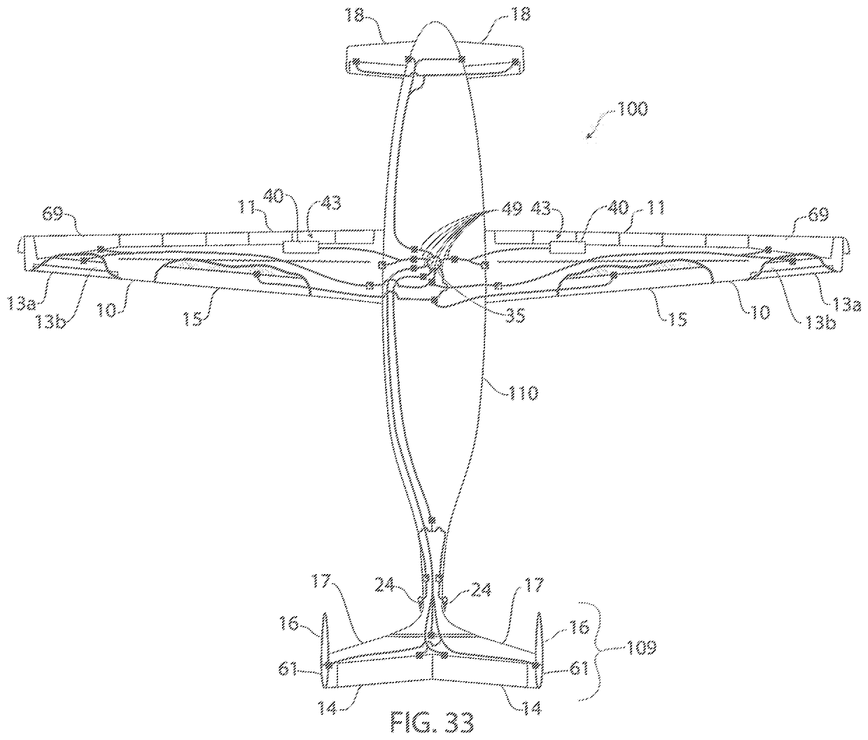

FIG. 33 Depicts the control valve compressed air supply distribution, which is supplied from the engines and/or APU, via the fuselage, canard, and empennage, and main wing function control compressed air supply lines 49 to the users as shown

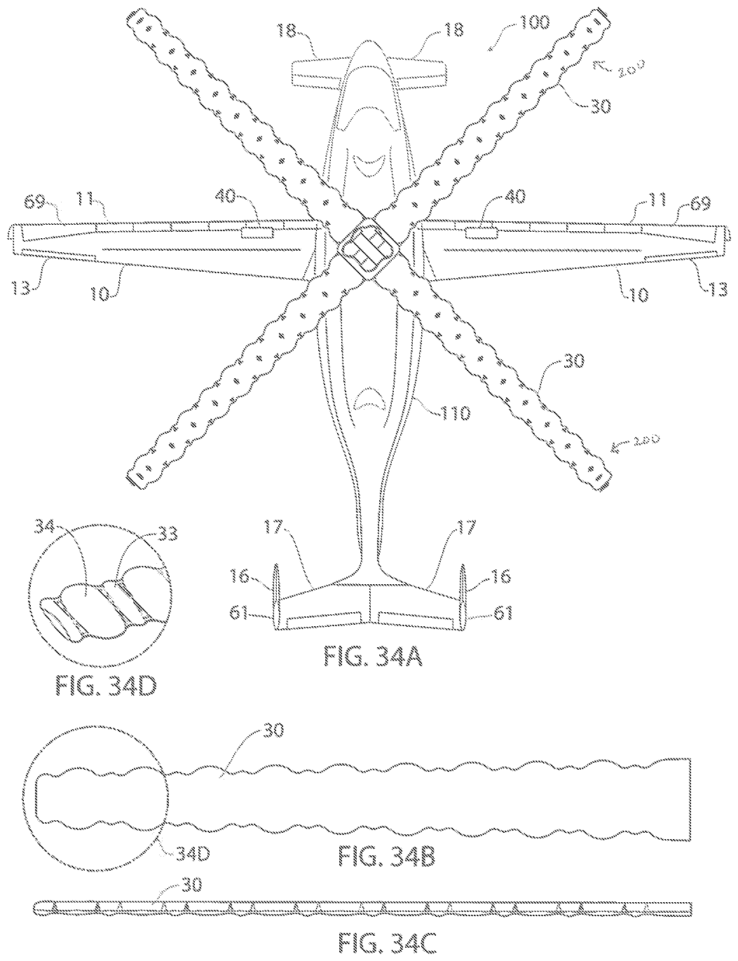

FIG. 34A shows a double stack of one of the interchangeable rotational lifting device designs. In this embodiment, an undulating airfoil shape on both the leading and trailing edges, as well as the upper and lower surfaces, creates a series of individual wing segments that can build lift regardless of the direction that the air passes over each segment. This results in an improved boundary layer attachment and lifting capacity. The diamond, triangle, and other symbols represent the various enhancement and control devices described and depicted in previous RLD embodiments.

FIG. 34B is used to reference locate the area depicted in FIG. 34D.

FIG. 34C depicts the RLD segment view towards the leading edge indicating the lower surface profile with a series of strakes protruding below the average surface level. This feature improves airflow towards a more perpendicular direction, which reduces tip vortex and increases pressure under the RLD.

FIG. 34D depicts an outer portion of the RLD as reference located from FIG. 34B. The contouring and undulating shape of this RLD surface are indicated.

Because there are different cord lengths, there are different airfoil stall characteristics. The contours between the two upper surface shapes results in different airflow speeds which creates small vortices, resulting in small areas of sheer which improves the boundary layer adhesion. Additionally, the lower surface has strakes and slight contouring which helps to direct the airflow in a direction that is more perpendicular to the span, which reduces tip vortex and increases under wing pressures. These features, combined with the laminar airflow and lift improvement devices previously explained, result in a high lift, high-powered airfoil, that can be flown in a much higher pitched angle of attack, with a greater safety margin to airfoil stall or retreating blade stall. Turbulence is reduced in the air encountered by the following RLD.

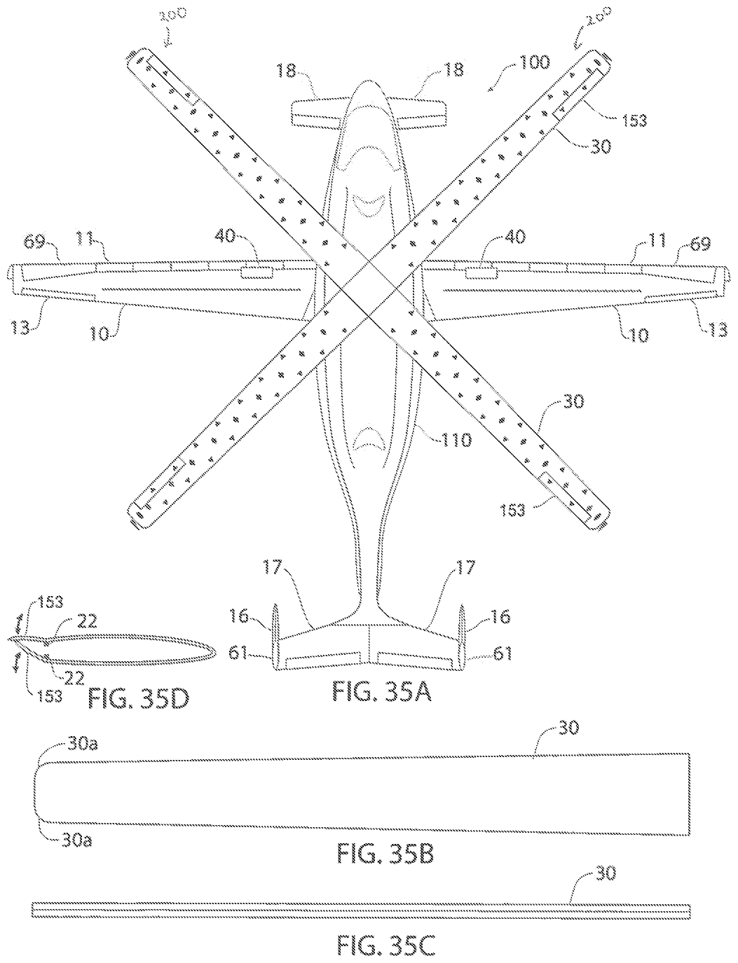

FIG. 35A B C shows a double stacked smooth surface rounded corner 30a interchangeable design. This embodiment could readily be used where extreme lifting capacity or very high speeds are not required, which would result in less complexity of manufacture and lighter component weight for relatively moderate speeds.

FIG. 35A shows a double stacked full span tapered RLD design, with rounded corners. however this embodiment is different than the previously shown design, in that this embodiment has Pneumatically operated Lift disc adjustment devices 153 that can be used to influence the attitude of the disc by cycling up and down throughout the rotation of the RLD in a manor similar to aileron deployment on an airfoil. The devices can also be used to create rotation of the RLD segment around its longitudinal axis and thereby causes further disk lift modulation. The ability to select one device up while the other is selected down can be used to rapidly slow and stop a rotating RLD, to assist in the parking sequence This variation would be well-suited to medium to high-speed where drag is a factor, while also being more efficient at lifting in hover mode.

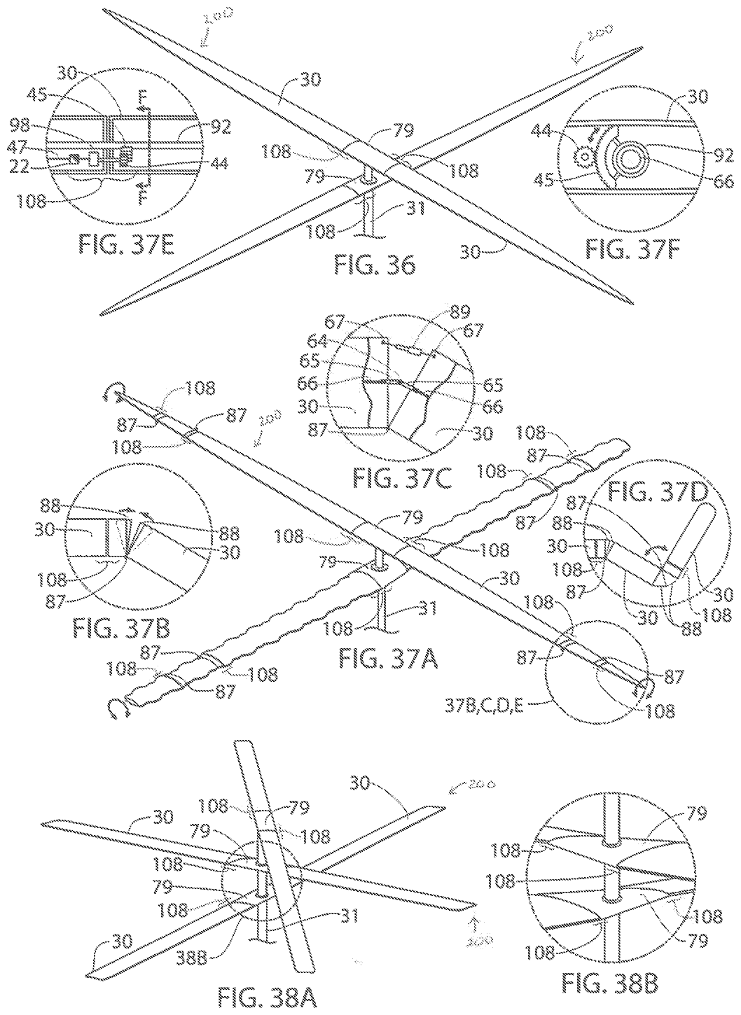

FIG. 35B&C depict the smooth profiles of this RLD design. FIG. 35D depicts the functionality of the Lift disc adjustment devices 153. For clarity of illustrative purposes, for the most part previous figures have shown and non-divided RLD. The following FIGS. 36, 37A, 38AB illustrate the correct method of division and joining shroud of the RLDs.

FIG. 36 shows a double stacked arrangement of RLD, but in this embodiment the airfoils are separated into two segments by the divided RLD route connection shroud 79 and which covers the transformable RLD section adjustment mechanism 108. This pneumatically driven mechanism, as further depicted in FIG. 37E,F, adjusts angle of incidence or pitch of the segment to be changed independently of the opposing section. The system is also capable of continuously altering the pitch of each section independently during the rotation of the RLD. In this manner, the lift disc could be modified and affected in a result similar to that of a conventional helicopter with cyclic and collective controls.

FIG. 37A shows a double stacked arrangement of two different rotational lifting device designs. This Embodiment indicates that the systems are interchangeable and compoundable. This figure also depicts the transformable RLD arrangement at the outer ends of the RLD separate segments. In one tip area the reference locater is seen.

FIGS. 37B,C,D,&E Depict a transformable rotor system, whereby the outboard portion of the rotor can be reconfigured in both angle of incidence and sweep. As shown in FIG. 37B and FIG. 37C and FIG. 37D the sweep of the two outboard sections can be altered to create both a swept-back and swept-forward orientation; including various combinations thereof. Additionally, as shown in FIGS. 37E and 37F, the angle of incidence (or pitch) of both outboard sections of the rotor can be altered.

The advantages of these transformable and variable features include: a reduced tendency to form rotor tip vortex, a reduction in drag, a reduction in rotor noise, a reduction in turbulent air intersection by the advancing rotor, a redistribution of the lifting forces of the rotor, which increases its' lifting capability, and increased lift disc modulation without using cyclic control. Additionally, the variable angles that can be created with these systems, make it possible to tailor the transformation to suit the individual mission requirements such as load, speed, stealth, agility, and hover lift density. These embodiments improve the controllability and capabilities of the aircraft both when using rotational lifting devices and when using transformed—fixed lifting devices, as well as during the transformation phase.

FIG. 37B shows the transferrable rotor extension vanes 88 that can be closed to present streamlining of that open hinged portion of the RLD segment. Also shown in FIG. 37B is the hinge 87 as well as the representation of the transformable RLD section AOI adjustment mechanism 108.

FIG. 37C shows the RLD spar hinge 64 and the RLD bar extension rail 65, along with the RLD extension retraction ram 89 attached to the ram pivot 67.

FIG. 37D shows representation of two transformable RLD section AOI adjustment mechanisms 108 and the accompanying extension vanes 88. Depicted here are two sweep positions; both swept back and swept forward. Although, for clarity, it is not shown, each segment is hinged on both edges and the extension ram 89 is present within both edges of the RLD at the hinge locations. This allows each hinged area to be opened in either direction. Also not shown for clarity, the functions are pneumatically powered from the RLD Control compressed air supply lines 47 which continue through the hinged area to the tip.

FIG. 37E shows the detail of the transformable RLD section AOI adjustment mechanism 108. As location referenced on FIG. 37A,B,C,D. As indicated here, the air supply lines 47 power the transformable RLD section AOI adjustment drive 98 to turn the transformable RLD AOI adjustment pinion gear 44, which travels on the transformable RLD AOI adjustment rack gear 45 to adjust the angle of incidence. Also shown in this figure is the reference locator F-F for FIG. 37F.

FIG. 37F depicts the pinion gear 44 and the rack gear 45 from an end cutaway view of the RLD spar 66 and the spar sleeve 92 to indicate the adjustments of pitch when activated. In these embodiments, the method used to cause transformation at the tip profile is a mechanical gear interface. An alternate embodiment could employ the extension and retraction of rams.

FIG. 38A shows a triple stack of the interchangeable smooth surface design with the rotational pairs off set at 60° to form a higher density lifting disc, which would also have a relatively low drag profile when placed in a perpendicular parked wing condition.

FIG. 38B depicts a rotational lifting device root-joining shroud 79, constructed with super-hydrophobic coated poly[dimethylsiloxane] or similar material that is expandable and stretchable while also retaining its initial shape when it is returned to its original orientation. As can be seen from FIG. 38B, The transition between lifting device segments is relatively smooth, even when in opposing pitch orientation. A typical helicopter mast head is thought to contribute about 20% of the total drag of the helicopter. This embodiment, will contribute little to no Drag.

FIG. 39A depicts both flaperon 13 and leading edge slats 11 and 28, as well as interceptor/spoilers 12. The flaperons 13 are two-stage ailerons composed of element 13a which is a smaller portion of the total aileron used for control at medium to high speed, combined with element 13b, the larger, normally retracted portion that is extended and used for added manoeuvrability control at slow speeds. The ailerons are denoted as flaperons because they extend in conjunction with and at similar angle of incidence to the flaps 15. When in their normal mode, partially retracted into the transformable main wing 10, as shown in FIG. 39A and FIGS. 39B and 39C, they present a very low-profile resulting in minimal drag, enabling efficient high-speed cruise and moderate speed manoeuvre. As the flaps are extended, so too are the ailerons, so when the aircraft is operated in the slow speed regime with flaps extended for greater lift, the ailerons also extend FIG. 39D for greater controllability and lift. Even when extended, as a result of the surface integration of the flap wing vane 62 and seal 29 they present a smooth non turbulent airflow, which reduces drag and improves function.

Although not shown in a figure, the spoiler/inceptor 12, as depicted in FIG. 39A is deployed by inter-connection with the aileron control, the adverse yaw correction vane 115, and thrust nozzle 23 so that the interceptor is raised on the one side, whenever there is a large aileron up control input on the same side. The rigging of these systems is biased to use the yaw correction vane in conjunction with the thrust nozzle for the first intervention and then add the spoiler if the deflection is extreme. This prevents adverse yaw at slow speeds.

The interceptor/spoiler panels can be raised independently of the Aileron control when speed reduction is needed.

FIG. 39E shows the split stream nozzle 28 incorporated into the leading edge of slat 11 shown as E-E on the right wing of FIG. 39A. When the nozzle is powered, the air is directed in streams over the upper and lower surfaces of the slat, as also shown in FIG. 100. This stream effect creates small shear vortices, which entrains air, increases underwing pressure, encourages cord wise laminar flow, improves the boundary layer attachment and laminar flow; which improves controllability at slow speeds. To further improve controllability at slow speeds, particularly in rough turbulent air, the leading edge slats 11 can be staggered in extension distance FIG. 39A to reduce the safety margin to airfoil stall. By staggering the extension of the slats, an early aerodynamic warning of approaching stall is observed.

FIG. 40A shows the RLD system HUB outer plenum/lower RLD support assembly 31, and RLD system HUB mid plenum/upper RLD support assembly 36, with the optional mechanical assistance or alternative drive system. The transmission 51, comprising the upper drive gear 51 and the lower drive gear 52, drive concentric shafts 54, 55, with gear ends 56 & 58 connected to gears 57 & 59 within the two independent rotational drive mechanisms 80, as shown in FIGS. 40B, 40C, and 40D. This embodiment can provide for additional mechanically driven rotation where extra torque is desired, or can be an alternate independent rotational power source, in lieu of an air driven system.

It will be appreciated by persons skilled in the art that the present invention is not limited by what has been particularly shown and described herein. Rather the scope of the present invention includes both combinations and sub-combinations of the features described herein as well as modifications and variations thereof which would occur to a person of skill in the art upon reading the foregoing description and which are not in the prior art. Furthermore, many alterations and modifications are possible in the practice of this invention without departing from the spirit or scope thereof. Accordingly, the scope of the invention is to be construed in accordance with the substance defined by the following claims.

What is claimed is:

1. An apparatus for providing lift to an aircraft comprising:
at least one rotating lifting device (RLD) formed of a pair of RLD segments extending from a common vertical support pivotally supported by said aircraft;
a drive operable to rotate said at least one RLD relative to said aircraft; and
a lock operable to fix said at least one RLD relative to said aircraft at a plurality of orientations.

2. The apparatus of claim 1 further comprising at least two RLDs coaxially and independently rotatably supported by the aircraft.

3. The apparatus of claim 2 wherein each of said at least two RLDs are rotatably supported on a drive hub.

4. The apparatus of claim 3 wherein each of said at least two RLD includes a locking extension selectably engageable upon said drive hub.

5. The apparatus of claim 4 wherein said locking extensions are receivable in apertures in said drive hub.

6. The apparatus of claim 5 wherein said drive hub includes a plurality of apertures disposed radially therearound so as to permit a plurality of locked orientations for each of said at least two RLDs.

7. The apparatus of claim 2 further comprising an interlock adapted to rotatably couple said at least two RLDs together.

8. The apparatus of claim 7 wherein said interlock comprises a receiver extending from at least one of said at least two RLDs having a plurality of apertures and at least one pin supported on an other of said at least two RLDs adapted to be selectably engageable within said one of said plurality of apertures.

9. The apparatus of claim 1 further comprising:
an air supply passage extending through each of said RLD segments, said air supply passage fluidically connected to a pressurized air supply within said aircraft; and
a plurality of air outlets disposed along each of said RLD segments in fluidic communication with said air passage.

10. The apparatus of claim 9 wherein said plurality of air outlets are disposed along at least one of a leading and trailing edges of said RLD segments.

11. The apparatus of claim 10 further comprising a plurality of air outlet nozzles along each of said leading and trailing edges.

12. The apparatus of claim 11 wherein said trailing edge outlets discharge air substantially along a chord of said RLD segments away therefrom.

13. The apparatus of claim 12 wherein said leading edge outlets discharge air along a top and bottom surface of said RLD segments in a direction extending from said leading edge to said trailing edge along said top and bottom surface of said RLD segments.

14. The apparatus of claim 13 wherein said leading and trailing outlets are substantially similar.

15. The apparatus of claim 14 wherein said plurality of outlets are formed of a cylinder extendable from said leading and trailing edge substantially along said chord of said RLD segments, each of said cylinder defining a selectably open central central passage along said chord and upper and lower bores passing through said cylinder.

16. The apparatus of claim 15 wherein said cylinder is extendable from said RLD segments so as to uncover said upper and lower bores.

17. The apparatus of claim 16 wherein said cylinder further includes a shield corresponding to the profile of said RLD segments extending from a distal end thereof and overlying said upper and lower bores so as to direct air discharged therefrom along top and bottom surfaces of said RLD segments.

18. The apparatus of claim 9 wherein said plurality of air outlets are adapted to provide a rotational force to each of said RLD segments.

19. The apparatus of claim 18 wherein said plurality of air outlets are located at distal ends of said RLD segments.

20. The apparatus of claim 19 wherein said plurality of air outlets are oriented perpendicular to said RLD segments.

21. The apparatus of claim 20 wherein said plurality of air outlets are rotatable about a length of each of said RLD segments.

22. The apparatus of claim 20 wherein said plurality of air outlets each includes two outlets disposed in opposite directions.

23. The apparatus of claim 9 wherein said plurality of air outlets comprise a plurality of linked pairs of air outlets.

24. The apparatus of claim 23 wherein said linked pairs of outlets comprise an edge outlet located proximal to one of a leading or trailing edge of said at least two RLD segments and a top outlet positioned through a top surface of said RLD segments at a position past a midpoint of said RLD segments.

25. The apparatus of claim 24 wherein said linked pair of outlets are connected by a passage extending therebetween.

26. The apparatus of claim 25 wherein passage is pressurized to direct air towards a trailing edge of said RLD segment.

27. The apparatus of claim 9 wherein said plurality of air outlets comprise a plurality of leading edge outlets proximal a leading edge and a plurality of trailing edge outlets proximal to a trailing edge of said RLD segments.

28. The apparatus of claim 27 wherein said leading outlets and said trailing outlets are connected by a bridging duct.

29. The apparatus of claim 28 wherein said bridging duct includes a modulating valve adapted to control the flow of air therethrough.
